(19) United States
(12) Patent Application Publication
(10) Pub. No.: US 2026/0204084 A1
(43) Pub. Date: Jul. 16, 2026

(54) SYSTEMS AND METHODS FOR PRODUCE RECOGNITION IN A RETAIL ENVIRONMENT

(71) Applicant: Datalogic IP Tech S.r.l., Calderara di Reno (IT)

(72) Inventors: Filippo MAMBELLI, Los Angeles, CA (US); Marco GUERRA, Montemurlo (IT); Andrea VIRGILLITO, Eugene, OR (US); Kilian LE CREURER, Aglientu (IT); Alessio PITTIGLIO, Cassino (IT); Roberto GIORDANO, Bologna (IT)

(21) Appl. No.: 19/445,291

(22) Filed: Jan. 9, 2026

Related U.S. Application Data
(60) Provisional application No. 63/743,990, filed on Jan. 10, 2025.

(51) Int. Cl. G06V 20/68; G06T 7/194; G06V 10/26; G06V 10/764; G06V 10/82; G07G 1/00; G07G 1/01

(52) U.S. Cl. CPC G06V 20/68; G06T 7/194; G06V 10/26; G06V 10/764; G06V 10/82; G07G 1/0072; G07G 1/01; G06T 2207/20081; G06T 2207/20084

(57) ABSTRACT

A produce recognition system is provided for a scanning system in a retail environment. The system includes a scanner including one or more imagers configured to capture images of an item within its field-of-view, and at least one processor operably coupled with the one or more imagers to receive the captured images and execute a neural network having a multi-input, multi-head architecture including: a foreground detection network configured to perform background subtraction to isolate the produce item in the foreground; a bag detection network configured to determine presence of a bag holding the item; and a produce rejection network configured to determine whether the item is a produce item or a non-produce item. Other related produce recognition method enhancements are also disclosed.

### PRIOR APPLICATION

This application claims the benefit of U.S. Provisional Application No. 63/743,990, filed Jan. 10, 2025, and entitled “SYSTEMS AND METHODS FOR PRODUCE RECOGNITION IN A RETAIL ENVIRONMENT,” the disclosure of which is incorporated by reference herein in its entirety.

### BACKGROUND

Grocery stores have greatly improved efficiency by the wide adoption of barcode readers that integrate with point-of-sale (POS) systems along with price look-up (PLU) databases. The efficiency has made it possible to reduce cost for grocery stores due to having fewer checkout attendants and faster checkouts for customers. One area in which efficiency still suffers is the ability for checkout attendants to process produce and various items that are not coded with machine-readable indicia (e.g., DataBar barcodes, conventional barcode, QR codes, digital watermarks, etc.). Because produce is not always readily or easily identified by checkout attendants or customers at self-checkout, and produce is difficult or not possible to mark with a machine-readable indicia, checkout attendants are often left with having to compare the produce with photographs of possible produce to determine how much to charge for the produce being purchased via a PLU database. Sometime systems may provide the customer with a picklist having a number of possible produce items to select from based on a match analysis of the item. Such an identification and look-up process is inefficient and often leads to incorrect results, such as when one produce variety (e.g., one type of lettuce) is misidentified as a different produce variety (e.g., another type lettuce). In addition to being a slow process, incorrectly identifying produce and other items leads to incorrect inventory counts in the retail store, thus leading to inefficiency in ordering and potentially loss of perishable items.

### BRIEF SUMMARY

A produce recognition system is provided for a scanning system in a retail environment. The system includes a scanner including one or more imagers configured to capture images of an item within its field-of-view, and at least one processor operably coupled with the one or more imagers to receive the captured images and execute a neural network having a multi-input, multi-head architecture including: a foreground detection network configured to perform background subtraction to isolate the produce item in the foreground; a bag detection network configured to determine presence of a bag holding the item; and a produce rejection network configured to determine whether the item is a produce item or a non-produce item.

### BRIEF DESCRIPTION OF THE DRAWINGS

FIG. 1 is a perspective view of a data reader according to an embodiment of the disclosure.

FIG. 2 is a perspective view of an illustrative data reader according to an embodiment of the disclosure.

FIG. 3 is a simplified block diagram of an illustrative data reading system according to an embodiment of the disclosure.

FIG. 4 is a simplified block diagram of certain components mounted on the main board according to an embodiment of the disclosure.

FIG. 5 is an image captured by a camera of a scanning system showing a user presenting one or more produce items to the scanner for purchase.

FIG. 6 is a simplified block diagram of the classification system illustrating a training scheme according to embodiments of the disclosure.

FIGS. 7A-7D show examples of images classified according in the top 4 results using a standard flat labels Classifier and for a PLU Hierarchical Classifier according to embodiments of the disclosure.

FIG. 8 is a block diagram of a neural network architecture according to embodiments of the disclosure.

FIG. 9 is a block diagram of a network training structure for the neural network of FIG. 8.

FIG. 10 is a block diagram showing additional expanded details of the neural network.

FIG. 11 is a block diagram illustrating an algorithm implemented in a method for computing reference color spectrum according to embodiments of the disclosure.

FIG. 12 shows results in the extraction of the three most representative colors, focusing on hue.

FIG. 13 shows a subset of reference images obtained by the filtering.

FIG. 14 is a block diagram illustrating a histogram matching process with corrections according to embodiments of the disclosure.

FIG. 15 shows results illustrating histogram matching with correction compared to without correction.

FIG. 16 illustrates the results illustrating the effect of the color correction network on 3 different group of images, in which the color corrected group is much more uniform.

FIG. 17 shows a table showing a comparison of classification results for datasets D1 and D2 under two conditions:

FIG. 18 is a block diagram providing details of an architecture for a multi-input, multi-head neural network according to embodiments of the disclosure.

FIG. 19 provides additional structure of the background subtraction network.

FIG. 20 shows a sample of foreground detection on a test dataset.

FIG. 21 is a histogram of the intersection over union between output of the network and GT of the foreground on a LAB dataset.

FIG. 22 is a graph showing a receiver operator characteristic curve for the bag detection according to embodiments of the disclosure as compared to a random classifier.

FIG. 23 is a graph showing the receiver operator characteristic curve for the produce rejection according to embodiments of the disclosure.

FIGS. 24A-24B are block diagrams for an architecture for a continuous learning system for produce recognition according to embodiments of the disclosure.

### DETAILED DESCRIPTION

The illustrations included herewith are not meant to be actual views of any particular systems, memory device, architecture, or process, but are merely idealized representations that are employed to describe embodiments herein. Elements and features common between figures may retain the same numerical designation except that, for ease of following the description, for the most part, reference numerals begin with the number of the drawing on which the elements are introduced or most fully described. In addition, the elements illustrated in the figures are schematic in nature, and many details regarding the physical layout and construction of a memory array and/or all steps necessary to access data may not be described as they would be understood by those of ordinary skill in the art.

As used herein, the singular forms “a,” “an,” and “the” are intended to include the plural forms as well, unless the context clearly indicates otherwise.

As used herein, “or” includes any and all combinations of one or more of the associated listed items in both, the conjunctive and disjunctive senses. Any intended descriptions of the “exclusive-or” relationship will be specifically called out.

As used herein, the term “configured” refers to a structural arrangement such as size, shape, material composition, physical construction, logical construction (e.g., programming, operational parameter setting) or other operative arrangement of at least one structure and at least one apparatus facilitating the operation thereof in a defined way (e.g., to carry out a specific function or set of functions).

As used herein, the phrases “coupled to” or “coupled with” refer to structures operably connected with each other, such as connected through a direct connection or through an indirect connection (e.g., via another structure or component).

Embodiments of the disclosure include systems and methods associated with performing produce recognition in a retail environment, such as a supermarket or grocery store. Embodiments may utilize various scanner for image capture of an item at checkout (such as at a self-checkout station). Such scanners may include, for example, cameras housed within a single plane or multi-plane (e.g., bioptic) scanner, a top-down reader attached to a fixed retail scanner, a presentation scanner, a peripheral scanner to the self-checkout station, an overhead scanner, and so on. An example of such a scanner system is described in is described in U.S. Pat. No. 12,045,686, issued Jul. 23, 2024, and entitled “FIXED RETAIL SCANNER WITH MULTI-PORT NETWORK SWITCH AND RELATED METHODS,” the disclosure of which is incorporated by reference herein in its entirety.

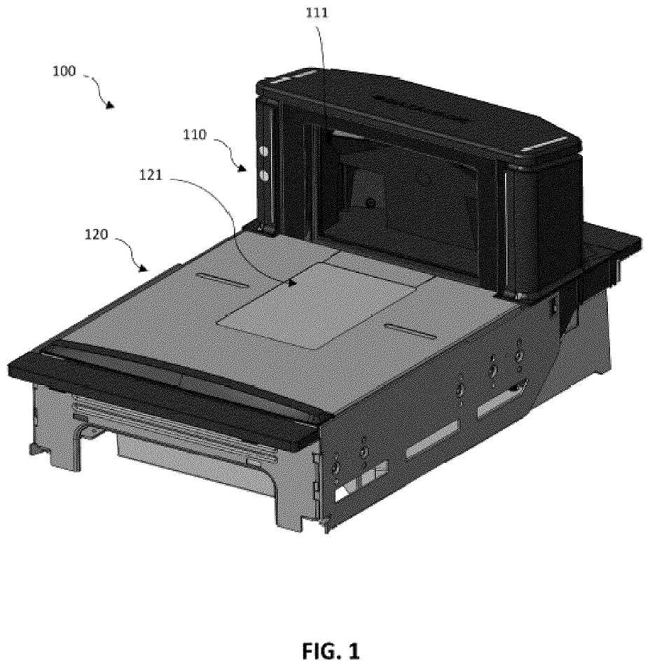

FIG. 1 is a perspective view of a data reader 100 (also referred to as a “scanner”) according to an embodiment of the disclosure. The data reader 100 may be a bi-optic fixed retail scanner having a vertical housing 110 and a horizontal housing 120. The vertical housing 110 may include a structure that provides for one or more camera fields-of-view (through a vertical window 111) within a generally vertical plane across the read zone of the data reader 100. The vertical structure provides an enclosure for one or more cameras and other optical elements (e.g., lenses, mirrors, etc.) and electrical elements (e.g., cables, circuit boards, etc.) therein. The horizontal housing 120 may include a structure that provides for one or more camera fields-of-view (through a horizontal window 121) within a generally vertical plane across the read zone of the data reader 100. The horizontal structure provides an enclosure for one or more cameras and other optical elements (e.g., lenses, mirrors, etc.) and electrical elements (e.g., cables, circuit boards, etc.) therein. Thus, the vertical housing 110 and the horizontal housing 120 may be generally orthogonal to each other (including slightly angled orientations, such as being in the range of ±10° from orthogonal). Depending on the arrangement and orientation of the different opto-electrical elements, certain elements related to providing a horizontal field-of-view may be physically located within the vertical structure and vice versa.

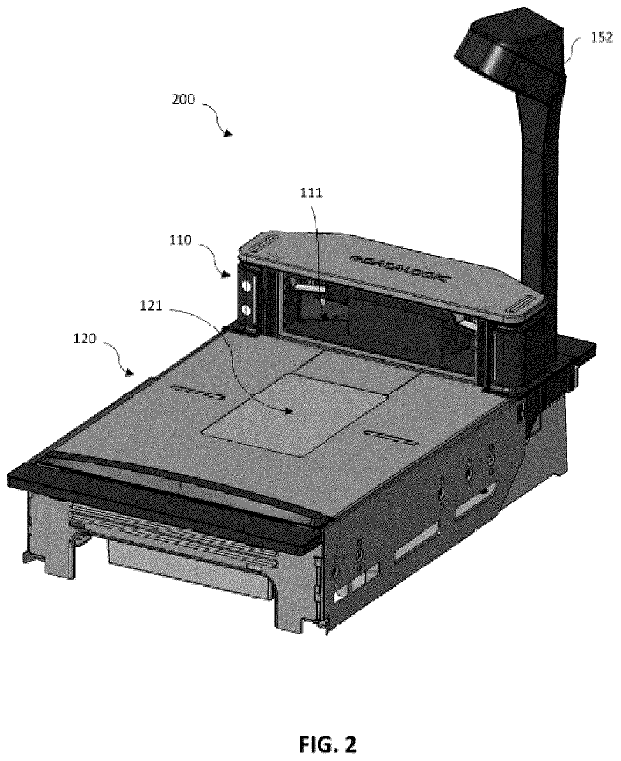

FIG. 2 is a perspective view of an illustrative data reader 200 according to an embodiment of the disclosure. As with the data reader of FIG. 1, the data reader of FIG. 2 may also be a bi-optic fixed retail scanner having a vertical housing 110 and a horizontal housing 120. The data reader 200 may also include a top-down reader (TDR) 152 that includes a stand connected to the data reader 100 with a head that includes one or more imagers therein. Such imager(s) typically provide a generally close overhead (angled) view of the read zone to provide a top view of a product whereas internal cameras may be better suited for capturing images of the bottom and/or sides of the object within the read zone.

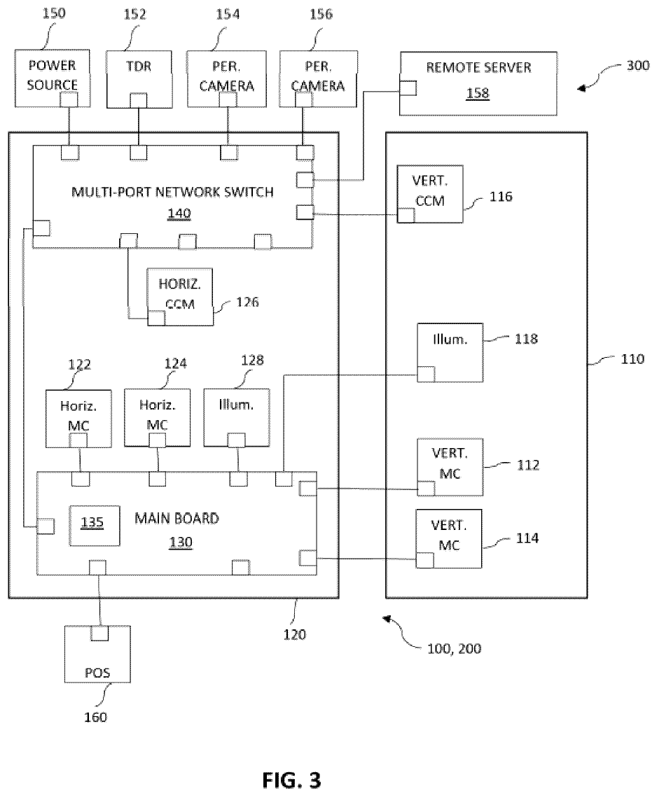

The vertical housing 110 of FIG. 2 may have a lower profile bonnet compared to that of FIG. 1, which may result in internal cameras having a lower incidence angle. Thus, such a form factor may be particularly well suited to include the TDR 152 (FIG. 3) as an optional add-on to the data reader 200. However, a TDR 152 may also be coupled to the data reader 100 of FIG. 1 having the taller bonnet. Such a TDR may need to be taller to accommodate the taller bonnet. In addition, some embodiments may include additional TDRs, such as on the other side of the bonnet, to provide another top view of the read zone. Thus, some embodiments may include one or more TDRs for data readers having different sized bonnets. It is also recognized that some embodiments may include single plane data readers such that certain features described herein are wholly located within a single plane housing (e.g., horizontal), which may further be coupled to other external devices or peripherals.

Different configurations and details regarding the construction and components of a fixed retail scanner are contemplated. For example, additional features and configurations of devices are described in the following patents and patent applications: U.S. Pat. No. 8,430,318, issued Apr. 30, 2013, and entitled “SYSTEM AND METHOD FOR DATA READING WITH LOW PROFILE ARRANGEMENT,” U.S. Pat. No. 9,004,359, issued Apr. 14, 2015, entitled “OPTICAL SCANNER WITH TOP DOWN READER,” U.S. Pat. No. 9,305,198, issued Apr. 5, 2016, entitled “IMAGING READER WITH IMPROVED ILLUMINATION,” U.S. Pat. No. 10,049,247, issued Aug. 14, 2018, entitled “OPTIMIZATION OF IMAGE FRAME MANAGEMENT IN A SWEEP-STYLE OPTICAL CODE DATA READER,” U.S. Pat. No. 10,248,896, issued Apr. 2, 2019, and entitled “DISTRIBUTED CAMERA MODULES SERIALLY COUPLED TO COMMON PREPROCESSING RESOURCES FACILITATING CONFIGURABLE OPTICAL CODE READER PLATFORM FOR APPLICATION-SPECIFIC SCALABILITY,” and U.S. Patent Application Publication No. 2020/0125812, filed Dec. 2, 2019, and entitled “DATA COLLECTION SYSTEMS AND METHODS TO CAPTURE IMAGERS OF AND DECODE INFORMATION FROM MACHINE-READABLE SYMBOLS,” the disclosure of each of which is incorporated by reference in their entirety. Such fixed retail scanners may be incorporated within assisted checkout stations having a clerk assisting a customer, while some embodiments include self-checkout stations in which the customer is the primary operator of the device. Such components and features may be employed in combination with those described herein.

FIG. 3 is a simplified block diagram of an illustrative data reading system 300 (also referred to as a “scanning system”) according to an embodiment of the disclosure. The data reading system 300 may include a data reader 100, 200 that may be operably coupled with one or more of a power source 150, the top-down reader (TDR) 152, peripheral cameras 154, 156, a remote service 158, or a point-of-sale (POS) system 160.

The data reader 100, 200 may be a bi-optic fixed retail scanner having a vertical housing 110 and a horizontal housing 120. The data reader 100, 200 may be installed in a retail environment (e.g., grocery store), which typically is disposed within a counter or other support structure of an assisted checkout lane or a self-checkout lane. The vertical housing 110 may include a structure that provides for one or more camera fields-of-view (through a vertical window) within a generally vertical plane across the read zone of the data reader 100, 200. The vertical structure provides an enclosure for one or more cameras 112, 114, 116, active illumination assemblies 118 (e.g., LED assemblies), and other optical elements (e.g., lenses, mirrors, etc.) and electrical elements (e.g., cables, circuit boards, etc.) therein. The horizontal housing 120 may include a structure that provides for one or more camera fields-of-view (through a horizontal window) within a generally vertical plane across the read zone of the data reader 100, 200. The horizontal structure provides an enclosure for one or more cameras 122, 124, 126, active illumination elements 128 (e.g., LED assemblies), and other optical elements (e.g., lenses, mirrors, etc.) and electrical elements (e.g., cables, circuit boards, etc.) therein. Thus, the vertical housing 110 and the horizontal housing 120 may be generally orthogonal to each other (including slightly angled orientations, such as being in the range of ±10° from orthogonal). Depending on the arrangement and orientation of the different opto-electrical elements, certain elements related to providing a horizontal field-of-view may be physically located within the vertical structure and vice versa.

The data reader 100, 200 may include one or more different types of imagers, such as monochrome imagers and/or color imagers. For example, vertical monochrome cameras 112, 114 may be configured to capture monochrome images through the vertical window of the data reader 100, 200. Likewise, horizontal monochrome cameras 122, 124 may be configured to capture monochrome images through the horizontal window of the data reader 100, 200. Vertical color camera module (CCM) 116 may be configured to capture color images through the vertical window of the data reader 100, 200. Likewise, horizontal color camera module (CCM) 126 may be configured to capture color images through the horizontal window of the data reader 100, 200. Monochrome images may be analyzed (e.g., by a decoder) to decode one or more indicia (e.g., 1D barcodes, 2D barcodes, optical character recognition, digital watermarks, etc.). Color images may be analyzed (e.g., by an image processor) to perform analysis on the images where color information may be particularly useful in performing certain functions, such as produce recognition, item recognition or verification, and/or security analysis. Such analysis may be performed by local and/or remote processors that may contain an artificial intelligence (AI) engine or otherwise configured to perform other machine learning techniques.

The data reader may further include a main board 130 and a multi-port network switch 140. As shown herein, the main board 130 and the multi-port network switch 140 may be physically housed within the horizontal housing 120. Bi-optic readers tend to have larger horizontal housings in order to provide support for the device within a cavity in a counter, which also provides space for a scale (not shown) used to weigh produce or other items sold by weight or otherwise perform weighing of items when placed on the horizontal surface (often called a “weigh platter”). It is contemplated that some embodiments may include the main board 130 and/or the multi-port network switch 140 to be physically located within the vertical housing 110. In such an embodiment where one of the multi-port network switch 140 or the main board 130 is physically located within the vertical housing 110 and the other is physically located within the horizontal housing 120, the two boards may be generally oriented orthogonal to each other similar to the orientation of the windows or other angled arrangements (e.g., slightly angled orientations such as being in the range of ±10° from orthogonal). The ports may be at least somewhat aligned in the orthogonal direction or other arrangement to accommodate easy connection of network cables therebetween.

The main board 130 may be operably coupled with the vertical monochrome imagers 112, 114 and the horizontal monochrome imagers 122, 124. These connections may be via a communication interface (e.g., a MIPI interface). The main board 130 may have decoding software embedded therein such that one or more on-board processors 135 may receive monochrome images to perform decoding on the optical indicia and provide the decoding result to a point-of-sale (POS) system 160 operably coupled thereto to complete a transaction. The one or more on-board processors 135 may also be configured to provide control (e.g., coordination or synchronization) of the various components of the system including camera exposure and timing of active illumination assemblies 118, 128 of the system. Although a single block is shown representing one or more on-board processors 135, it is contemplated that some embodiments may include multiple processing components (e.g., microprocessors, microcontrollers, FPGAs, etc.) configured to perform different tasks, alone or in combination, including object detection, system control, barcode decoding, optical character recognition, artificial intelligence, machine learning analysis, or other similar processing techniques for analyzing the images for product identification or verification or other desired events.

The multi-port network switch 140 may be operably coupled to vertical CCM 116 and horizontal CCM 126 located within the data reader 100, 200. The multi-port network switch 140 may also be operably coupled with main board 130 located within the data reader 100, 200. Multi-port network switch 140 may also be operably coupled to the power source 150 as well as peripheral devices, such as the TDR 152, peripheral cameras 154, 156, and/or the remote server 158. The number, and types of peripheral devices, may depend on a desired application within a retail environment. The TDR 152 may be configured as a stand connected to the data reader 100, 200 that typically provides a generally close overhead (angled) view of the read zone to provide a top view of a product whereas internal cameras 112, 114, 116, 122, 124, 126 may be better suited for capturing images of the bottom and/or sides of the object within the read zone. Peripheral cameras 154, 156 may be located remotely from the data reader 100, 200, such as being mounted on a ceiling or wall of the retail environment to provide additional views of the read zone or checkout area. Such views may be useful for security analysis of the checkout area, such as product verification, object flow, human movements, etc. Such analysis may be performed by a remote service or other local devices (e.g., located on or otherwise coupled to the main board 130 or multi-port network switch 140). Other peripheral devices may be located near the data reader 100, 200, such as a peripheral presentation scanner resting or mounted to a nearby surface, and/or a handheld scanner that also may be used for manual capturing by the user (e.g., checkout assistant or self-checkout customer). Such devices may be coupled directly to the main board 130 in some embodiments or to the multi-port network switch 140 if so enabled. As shown, the POS system 160 may be coupled directly to the main board 130. Such a connection may be via communication interfaces, such as USB, RS-232, or other such interfaces. In some embodiments, the POS system 160 may be coupled directly to the multi-port network switch 140 if so enabled (e.g., as an Ethernet connected device).

The multi-port network switch 140 may be implemented on a separate board from the main board 130. In some embodiments, the multi-port network switch 140 may be implemented on the main board 130 that also supports the one or more processors 135 also described herein. The multi-port network switch may include multiple ports to provide advanced network connectivity (e.g., Ethernet) between internal devices (e.g., CCMs 116, 126) within the data reader 100, 200 and external devices (e.g., TDR 152, peripheral camera(s) 154, 156, remote server 158, etc.) from the data reader 100, 200. Thus, the multi-port network switch 140 may provide an Ethernet backbone for the elements within the data reader 100, 200 as well as for external devices coupled to the data reader 100, 200 for control and/or managing data flow or analysis. As an example, multi-port network switch 140 may be implemented with a KSZ9567 Ethernet switch or other EtherSynch® product family member available from Microchip Technology Inc of Chandler, Arizona or other similar products and/or devices configured to provide network synchronization and communication with multiple network-enabled devices. Embodiments of the disclosure may include any number of ports supported by the multi-port network switch to couple to both internal devices (e.g., main board, cameras, etc.) and external devices (e.g., peripheral cameras, TDR, illumination sources, remote servers, etc.) to provide a flexible platform to add additional features for connecting with the data reader 100, 200.

Although FIG. 3 shows one block for active illumination assemblies 118, 128 in each of the vertical and horizontal housings 110, 120, some embodiments may include multiple such assemblies in each of the horizontal and vertical housings 110, 120 in order to provide for different lighting options at different angles across the read zone. For example, the vertical housing 110 may include two (or more) illumination assemblies therein at different locations and/or different colors for a desired illumination field from the vertical view. Likewise, the horizontal housing 120 may include two (or more) illumination assemblies therein at different locations and/or different colors for a desired illumination field from the horizontal view. As shown herein, the illumination assemblies 118, 128 may be coupled directly to the main board 130. However, in some embodiments, additional components may be coupled within the path from the main board 130, such as a control panel or other such device. In yet other embodiments, the illumination assemblies 118, 128 may be coupled to the multi-port network switch 140 which may route triggering controls from the main board 130. TDR 152 and one or more of the peripheral cameras 154, 156 may also include associated illumination assemblies. Synchronization of such illumination sources may be managed by the multi-port network switch 140 as controlled by the main board 130. In some embodiments, the multi-port network switch may employ or leverage IEEE1588 Precision Time Protocol to synchronize the illumination system with remote cameras, which may enable clock accuracy in sub-microsecond range.

In operation, images may be captured by the cameras 112, 114, 116, 122, 124, 126. Monochrome images may be captured by monochrome cameras 112, 114, 122, 124 and color images may be captured by color cameras 116, 126. The multi-port network switch 140 may be configured to coordinate (e.g., synchronize) timing of camera exposure and active illumination (e.g., white illumination) with the color cameras 116, 126 (as controlled by the controller on the main board 130) to occur in an offset manner with the timing of the camera exposure and active illumination (e.g., red illumination) with the monochrome cameras 112, 114, 122, 124.

Image data (e.g., streaming video, image frames, etc.) from the color cameras 116, 126 may be routed through the multi-port network switch 140 to the processing/analysis modules located internal to the data reader 100, 200, such as the one or more processors 135 supported by the main board 130. As such, image analysis (e.g., AI, machine learning, OCR, object recognition, item validation, produce recognition, analytics, etc.) may be performed on the color images internally within the data reader 100, 200 by the one or more processors 135 supported by the main board 130. In some embodiments, barcode decoding may also be performed on the color images internally within the data reader 100, 200 by the one or more processors 135 supported by the main board 130. Image data from the color cameras 116, 126 may also be routed through the multi-port network switch 140 to external devices, such as remote server 158 or other similar devices including any network enabled POS systems. As such, image analysis (e.g., AI, machine learning, OCR, object recognition, item validation, produce recognition, analytics, etc.) may be performed on the color images externally to the data reader 100, 200 by external devices coupled through the multi-port network switch 140. Such color images or other data stream may be routed directly to the network connected external devices through the multi-port network switch 140 without first being received by the main board 130 (if at all). In other words, image data may be communicated (e.g., passed) from at least one imager internal to the data reader through the at least one multi-port network device 140 and on to at least one external device bypassing the main board 130. Having a connection to both the main board 130 as well as to external devices via the multi-port network switch enables image data to be provided to internal as well as external processing resources.

Image data from the monochrome cameras 112, 114, 122, 124 may be provided to the main board 130 to the processing/analysis modules located internal to the data reader 100, 200 such as the one or more processors 135 supported by the main board 130. As such, barcode decoding may also be performed on the color images internally within the data reader 100, 200 by the one or more processors 135 supported by the main board 130. In some embodiments, image analysis (e.g., AI, machine learning, OCR, object recognition, item validation, produce recognition, analytics, etc.) may be performed on the monochrome images internally within the data reader 100, 200 by the one or more processors 135 supported by the main board 130. Image data from the monochrome cameras 112, 114, 122, 124 may also be routed through the multi-port network switch 140 to external devices, such as remote server 158 or other similar devices including any network enabled POS systems. As such, image analysis (e.g., AI, machine learning, OCR, object recognition, item validation, produce recognition, analytics, etc.) may be performed on the monochrome images externally to the data reader 100, 200 by external devices coupled through the multi-port network switch 140. Such monochrome images or other data stream may be routed directly to the network connected external devices to the multi-port network switch 140 after first being received by the main board 130.

Image data (e.g., streaming video, image frames, etc.) from the TDR 152 or other external peripheral cameras 154, 156 may be routed through the multi-port network switch 140 to the processing/analysis modules located internal to the data reader 100, 200, such as the one or more processors 135 supported by the main board 130. As such, image analysis (e.g., AI, machine learning, OCR, object recognition, item validation, produce recognition, analytics, etc.) may be performed on the images (e.g., color and/or monochrome) internally within the data reader 100, 200 by the one or more processors 135 supported by the main board 130. In some embodiments, barcode decoding may also be performed on such images internally within the data reader 100, 200 by the one or more processors 135 supported by the main board 130. Image data from the TDR or other external peripheral cameras 154, 156 may also be routed through the multi-port network switch 140 to external devices, such as remote server 158 or other similar devices including any network enabled POS systems. As such, image analysis (e.g., AI, machine learning, OCR, object recognition, item validation, produce recognition, analytics, etc.) may be performed on these images externally to the data reader 100, 200 by external devices coupled through the multi-port network switch 140. Such images or other data stream may be routed directly to the network connected external devices through the multi-port network switch 140 without first being received by the main board 130 (if at all).

The multi-port network switch 140 may be coupled to the main board 130 via a single cable configured to provide power and communication to the main board 130. Power may be provided to the system via power source 150 via the multi-port network switch 140, which in turn provides power (e.g., power over Ethernet (POE)) to the main board 130 and the color cameras 116, 126. Monochrome cameras 112, 114, 122, 124 and illumination assemblies 118, 128 may be powered via the main board 130.

Features of employing the multi-port network switch 140 as a primary backbone for communication and power to interface between both internal and external components of the system include enabling power, communications, and camera/illumination synchronization to occur over a single cable between such connected components. In addition, precision time protocol (PTP), generic precision time protocol (GPTP), time sensitive networking (TSN) may provide an improved synchronization (e.g., within 1 microsecond error) for an open standard, widely supported, single cable solution. In addition, scanner maintenance tools may be simplified via improved network connectivity.

In some embodiments, the multi-port network switch 140 may be disposed within an external module having its own housing separate from the data reader 100. The multi-port network switch 140 may, thus, be located outside of the bi-optic housing of the data reader 100 but may operably couple to the main board 130 and internal devices (e.g., vertical CCM 116, horizontal CCM 126) as well as other external devices (e.g., TDR 152, cameras 154, 156, server 158, etc.) for providing the network backbone for communication and/or power as described above.

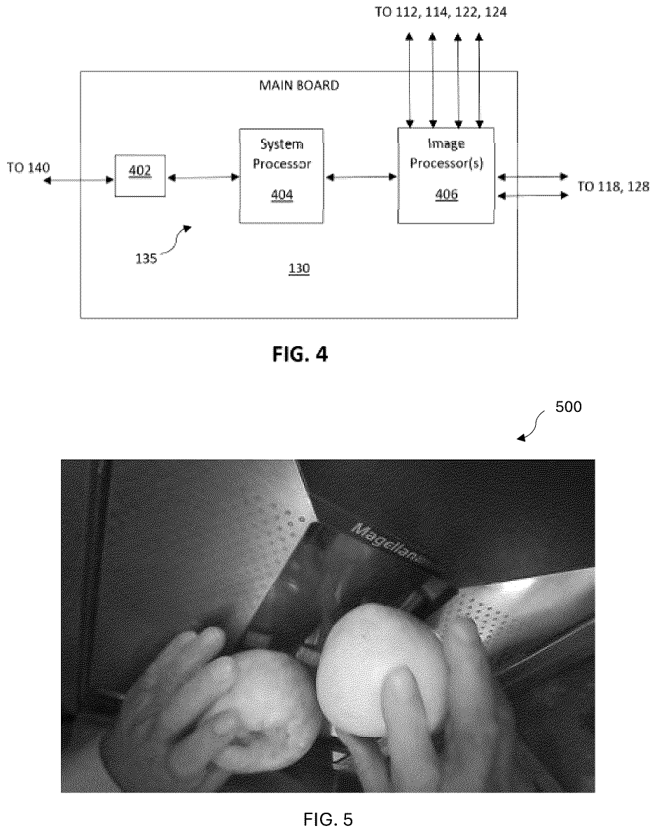

FIG. 4 is a simplified block diagram of certain components mounted on the main board 130 according to an embodiment of the disclosure. In particular, further details are provided regarding the one or more processors 135 that may include an Ethernet physical layer 402, a system processor 404, and an image processor 406. Additional processing elements are also contemplated among the one or more processors 135, such as, for example, an artificial intelligence (AI) accelerator disposed on the main board 130 and coupled to the system processor 404 (e.g., via insertion into a PCIe slot on the main board 130).

The system processor 404 may be coupled to each of the Ethernet physical layer 402 and the image processor 406. The Ethernet physical layer 402 may be coupled with the multi-port network switch 140 to provide an interface between the main board 130 and the multi-port network switch 140. The image processor 406 may be coupled to the monochrome imagers 112, 114, 122, 124 to provide control (e.g., sync signal) and to receive monochrome images therefrom. The image processor 406 may be configured to receive and format image data from the cameras 112, 114, 122, 124 before being received by the system processor 404. In some embodiments, multiple image processors may be present such that each camera 112, 114, 122, 124 may have its own image processor associated therewith. In some embodiments, cameras may share an image processor for transmission to the system processor 404. For example, a single image processor (e.g., FPGA) may be configured to combine (e.g., concatenate) the image data from each of the monochrome cameras 112, 114, 122, 124 for the system processor to receive multiple views at a single point in time through one input. An example of such a process is described in U.S. Patent Publication No. 2022/0207969, filed Dec. 31, 2020, and entitled “FIXED RETAIL SCANNER WITH ANNOTATED VIDEO AND RELATED METHODS,” the disclosure of which is incorporated by reference in its entirety. Image processor 406 may also be coupled to the illumination assemblies 118, 128 to provide control thereto (e.g., sync signal). In some embodiments, the sync signal may be generated by one of the Ethernet physical layer 402 or the system processor 404, and which may be based on a system clock signal.

Embodiments of the disclosure may include produce recognition systems and related methods of produce (e.g., fruits, vegetables) recognition by a retail scanner (e.g., self-checkout scanners), such as those described above with respect to FIGS. 1-4. Produce recognition systems (also referred to as “modules”) modules may be implemented by trained artificial intelligence (AI) models that may be embedded within the scanner and/or external devices (e.g., cloud-based services). Thus, processes may be executed by a processor (e.g., a system processor, co-processor, etc.) executing an AI accelerator module housed within the scanner to perform produce recognition during a transaction. Such produce recognition may assist in identifying produce for providing a more seamless transaction by reducing user input and/or may provide more accuracy in the transaction that may reduce loss to the store-whether it may be unintentional error by the customer or intentional error (e.g., shoplifting). Thus, various embodiments of the disclosure may provide improvements to the operation of the scanner itself in accurately identifying produce, improving upon errors, etc., while some embodiments of the disclosure may also provide benefits appreciated by the customer or the retail establishment.

### PLU Hierarchical Classifier

In some embodiments, the produce recognition system may be include a price look-up (PLU) hierarchical classifier for providing perceptually coherent top N results in produce classification. The objective of a produce recognition system in some embodiments may be to generate a ranked list of the top N classifications for a given image captured by the scanner. The primary aim is to accurately identify a specific type of produce, such as an “Apple Gala,” from a list of all possible produce items available in a store.

These produce recognition systems include artificial intelligence (AI) or other neural network machine learning models that are typically trained by minimizing a loss function associated with classification accuracy. This approach can result in high accuracy for the top N classification outcomes, meaning the system strives to maximize the likelihood of correctly identifying the produce within the top N suggestions. While the typical approach is suitable for producing one correct result from the proposed N suggestions, the approach may not ensure the quality of the other suggested items. What may be perceived as similar or plausible by a user may not always align with the neural network's internal representation.

Even a system with a high Top 4 accuracy (i.e., a system with a high percentage of correctly classified items in the top 4 presented results) may provide a list that appears as a random selection of items to the user. This may occur because the features the neural network uses to identify similarity among produce items may not be perceived as relevant by humans.

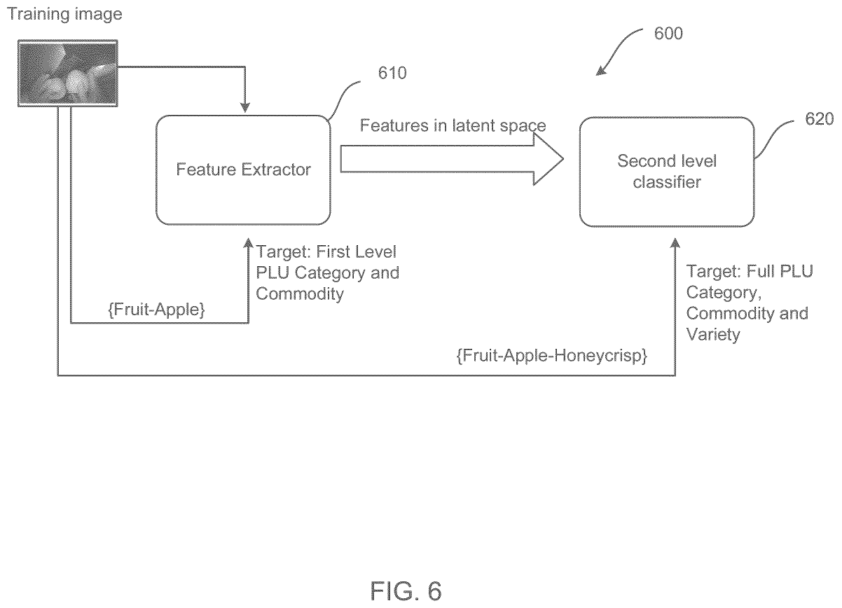

FIG. 5 is an image captured by a camera (e.g., a top-down imager) of a scanning system showing a user presenting one or more produce items to the scanner for purchase. The produce recognition system may generate a Top 4 classification result (e.g., “Mango-Red,” “Apples-Honeycrisp,” “Potato-YukonGold,” “Bananas”) using a classifier trained with a standard loss function aimed at minimizing classification errors on produce classes, which can include the correct prediction (e.g., “Apples-Honeycrisp”), but the other predictions (e.g., “Mango-Red,” “Potato-YukonGold,” “Bananas”) may seem completely unrelated.

This lack of coherence in the results can distort the user's perception of the system's accuracy. Users must evaluate the system's trustworthiness based on a limited set of examples, so the more coherent the results appear, the easier it is for users to assess the system's quality. Additionally, a system trained as a traditional classifier, without constraints on the relationships between the Top N results (other than those automatically learned during training), may suggest much cheaper alternatives to the correct item (e.g., “Potato” instead of “Mango”). This mismatch can result in financial losses for the store.

Embodiments of the disclosure may address these issues by implanting a method of training a system that, while maintaining accuracy in the Top 4 presented classes, offers users results that are perceived as coherent and hierarchically related according to a natural human understanding of produce relationships. The produce recognition classifier may be configured as an open world, continual learning classifier. This classification system may be configured to operate within the open-world paradigm, where it encounters a vast and potentially unlimited set of classes or categories. To address this inherent complexity, the classification system is configured to employ a two-stage approach including an embedded network and a second-stage classifier.

### Embedded Network (Feature Extractor)

The classification system may begin with an embedded network, typically a deep neural network architecture, such as a convolutional neural network (CNN), a transformer-based model, or the like. This network may be responsible for extracting high-level features from input data, such as images, text, or other types of data. During training, the embedded network learns to represent the essential characteristics of input data in a lower-dimensional feature space. This representation may be capable of capturing common patterns and features across a wide variety of classes.

### Second-Stage Classifier

After feature extraction, the classification system feeds the extracted features into a second-stage classifier. This classifier is often a machine learning model, such as a linear classifier or a more sophisticated algorithm, such as a support vector machine (SVM) or Gaussian Mixture Model (GMM).

The second-stage classifier's primary role is to map the extracted features into class predictions. The second-stage classifier may be trained to recognize patterns specific to known classes, and may be expanded by training with examples of new classes (unseen at training time of the feature extractor).

In summary, this classification system may combine the power of an embedded network for feature extraction with a second-stage classifier to make class predictions. The classification system may be designed to operate in an open-world environment, where new classes can emerge over time. To maintain adaptability, the classification system may be configured to incorporate mechanisms for handling unknown classes and train the second stage classifier on novel classes.

In order to improve classification results, embodiments of the disclosure may train this two stage classifier to incorporate the knowledge of hierarchical relationship between produce and therefore produce results Top N perceptually more coherent.

### PLU Hierarchical System

The majority of grocery store products are classified using the international price look-up (PLU) system, which provides a unique identifier for each product. Embodiments of the disclosure may include a three-level hierarchical classification system consisting or inclusive of of PLU Category, Commodity, and Variety.

For instance, consider the Honeycrisp apple:
PLU Category: Fruit
Commodity: Apple
Variety: Honeycrisp

While there may be over 1400 unique global PLU codes, there may be approximately 100 distinct Commodities organized into five different PLU Categories. The PLU Categories may include Fruit, Herbs, Vegetable, and Dried Fruit, while examples of Commodities include Apple, Pears, Tomatoes, and more.

Exploiting this naturally generated human taxonomy can be beneficial in the training process of a two-stage system classifier. Specifically, the feature extractor may be trained by using only the PLU Category and Commodity level descriptions of the products depicted in the training images as the target for a loss function. Meanwhile, the full flattened out nomenclature, including the Variety, may be used to train the second-level classifier.

This approach enables the capability to be embedded in the feature extraction process to group together latent representations of products that belong to the same PLU Commodity (for example, all types of apples vs. all types of potatoes) and then differentiate them by Variety (e.g., Honeycrisp apples vs. Gala apples) during the training of the second-level classifier.

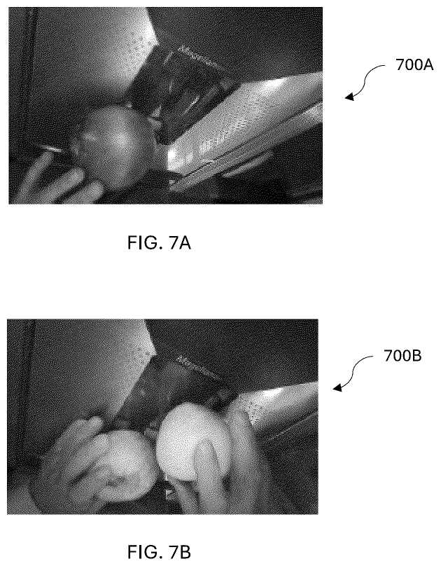

FIG. 6 is a simplified block diagram of the classification system 600 illustrating a training scheme according to embodiments of the disclosure. The classification system includes a two stage approach including a feature extractor 610 and a second level classifier 620 configured as described above. In some embodiments, a Convolutional Neural Network (CNN), specifically utilizing architectures such as MobileNet or DenseNet may be employed as the feature extractor 610. This CNN backbone produce an embedding vector of length 128. Subsequently, a Gaussian Mixture Model (GMM) may be employed as a second-stage classifier 620.

In some embodiments, different training approaches may be employed for the feature extractor 610: one using categorical cross-entropy loss and the other utilizing a performance-contrastive loss. In both cases, the target for training may be the commodity level description associated with the PLU code. These training methods encourage the resulting embeddings to push items belonging to the same PLU Commodity closer together in a specific metric space. Given the use of a GMM as the second-stage classifier, both training methods may yield similar performance. However, in scenarios where a k-Nearest Neighbors (KNN) classifier serves as the second stage, contrastive loss may be preferable.

Experiments have revealed that training the feature extractor with the PLU Commodity as the target produces embeddings that generalize better in relation to achieving higher performance in the Top 4 accuracy compared to an equivalent system trained solely on the flatten PLU classes.

When training the feature extractor with flatten PLU classes, the network faces the same loss when misclassifying one kind of apple as a different apple variety compared to misclassifying it as a banana. As a result, the classification task may be more challenging and less amenable to generalization. Conversely, when training the feature extractor using the PLU Commodity level within the hierarchy, the classification task may become more straightforward. This is because items belonging to different PLU Commodities may be more likely to be dissimilar than items within the same PLU Commodity. A classifier leveraging a feature extractor trained in this manner tends to generalize more effectively and converge to a more stable minimum. Consequently, it results in a more consistent classifier performance across different datasets, as corroborated by experimental findings.

### Results

To assess the performance of the classifier, experiments have used two distinct datasets:
Dataset D1: This dataset comprises approximately 62,000 images, which were used for both training and testing.
Dataset D2: In contrast, D2 serves as a standalone test dataset, comprising roughly 17,500 images. This dataset exhibits variations in lighting conditions and class distribution compared to D1.

To ensure robust evaluation, a K-fold method may be applied to partition the images in D1 into five sub-datasets: Fold 0, Fold 1, Fold 2, Fold 3, and Fold 4. Each fold is comprised of both a training dataset (approximately 49,000 images) and a test dataset (around 12,500 images).

Consequently, five separate classifiers were trained, one for each fold. These classifiers were trained using two different approaches:
1. Flat Class Training: In this approach, the Feature Extractor of each classifier were trained without considering the hierarchical structure of PLU codes. All class distinctions, including Variety, were utilized during training as a flatten down label.
2. PLU Commodity Training: In contrast, this approach trained the classifiers while focusing only on the PLU Category and Commodity levels, omitting the Variety level during training of the Feature Extractor.

For both tests a GMM may be trained on the features extracted using Feature Extractor in the first stage and as target ground truth the flatten down PLU label. The performance of these five classifiers was then assessed across the different test folds of D1 and on the D2 test dataset. This comparison allows an evaluation of the impact of training with a hierarchical PLU Commodity approach versus a flat class approach across various test scenarios.

To gauge the perceptual coherence of the proposed Top 4 results generated by this newly trained system in comparison to a system trained on a flattened labels classes, the percentage of items within the top 4 results that belong to the same category as the ground truth are measured. For instance, if the image represents a Roma tomato, the number of items in the top 4 are calculated that fall under the Tomato PLU commodity category.

Experiments have shown that top 4 recall for all the classifiers are equivalent if not better for D1 dataset, while for D2 dataset the PLU Hierarchical Classifier may generalize better and produce consistently better performance. More importantly, there was a clear improvement on the percentage of item presented in the top 4 that belongs to the same category of the ground truth, which may be a useful estimator of the perceptual coherence of the results presented to the user.

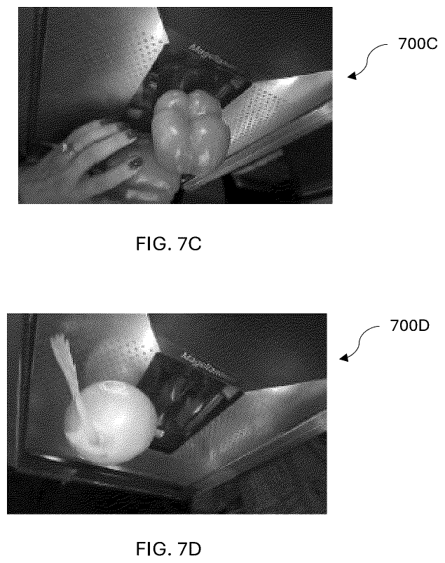

FIGS. 7A-7D show examples of images 700A-700D classified according in the top 4 results using a standard flat labels Classifier and for a PLU Hierarchical Classifier according to embodiments of the disclosure. Using conventional produce classification methods, inputting image 700A may result in a top 4 results of: Mango—Red; Pears—Red; Apple—Gala; Onion—Red (with Onion—Red being the correct result). Using PLU Hierarchical classification methods according to embodiments of the disclosure, inputting image 700A may result in a top 4 results of: Onion—Red; Onion—SweetRedItalian; Onion—OtherSweet; Mango—Red. Inputting image 700B may result in a top 4 results of: Mango—Red; Apples—Honeycrisp; Potato—YukonGold; Bananas using conventional methods vs. Apples—Opal; Apples—Gala; Apples—Ambrosia; Apples—Honeycrisp using the PLU Hierarchical classification method (with Apple-Honeycrisp being the correct result). Inputting image 700C may result in a top 4 results of: Peppers—Bell, Red; Pears—Red; Bananas; Tomatoes—Heirloom using conventional methods vs. Peppers—Bell, Red; Peppers—Bell, Orange; Peppers—Bell, Green, Red; Peppers—Bell, Yellow using the PLU Hierarchical classification method (with Peppers—Bell, Red being the correct result). Inputting image 700D may result in a top 4 results of: Onions—Yellow, Brown; Tomatoes—Regular, Red; Tomatoes—Heirloom; Apples—Pink using conventional methods vs. Onions—Yellow, Brown; Onions—Shallots; Onions—OtherSweet; Onions—White using the PLU Hierarchical classification method (with Onions-Yellow being the correct result). While both methods may correctly identify the produce among the top 4 results in these examples, the quality (coherence) of the top 4 results are improved in the second instance.

### Deep Learning Color Correction Architecture

Embodiments of the disclosure may also include a deep learning color correction architecture for produce image classification. In some embodiments, a deep neural network known as an embedder may be employed for such classification. This embedder serves to project images of produce into a latent feature space, after which the resultant vectors are input into a classifier. To effectively train the embedder network, a substantial dataset comprising a large number of images is needed for the training set.

However, a challenge arises when there is a lack of control over the lighting conditions and white balance in the environment where the system will be deployed. There are several reasons for this:
Color plays a crucial role in image classification, particularly in fine-grained produce recognition, as many produce items have similar shapes.
Training the embedder with heavy color jitter augmentation (to simulate various lighting conditions) can diminish the network's ability to create embeddings capable of distinguishing items by their color. This results in the network becoming less sensitive to subtle color variations.

Embodiments of the disclosure may be configured to implement a color correction system to ensure that the lighting conditions in the deployment environment more closely match those of the training set. As a result, the colors of the produce items captured in images in the real-world application field may closely resemble the colors of the items in the training set.

There are two key considerations for developing such a system:
Speed is crucial for the color correction algorithm. Therefore, a neural network may be utilized for this purpose.
The correction process should not compromise the image's content or generate non-existent details. This ensures that the corrected images remain faithful to the original.

Embodiments of the disclosure include a neural network architecture configured to execute real-time color correction: a U-Net architecture based on MobileNet, DenseNet, or other CNN.

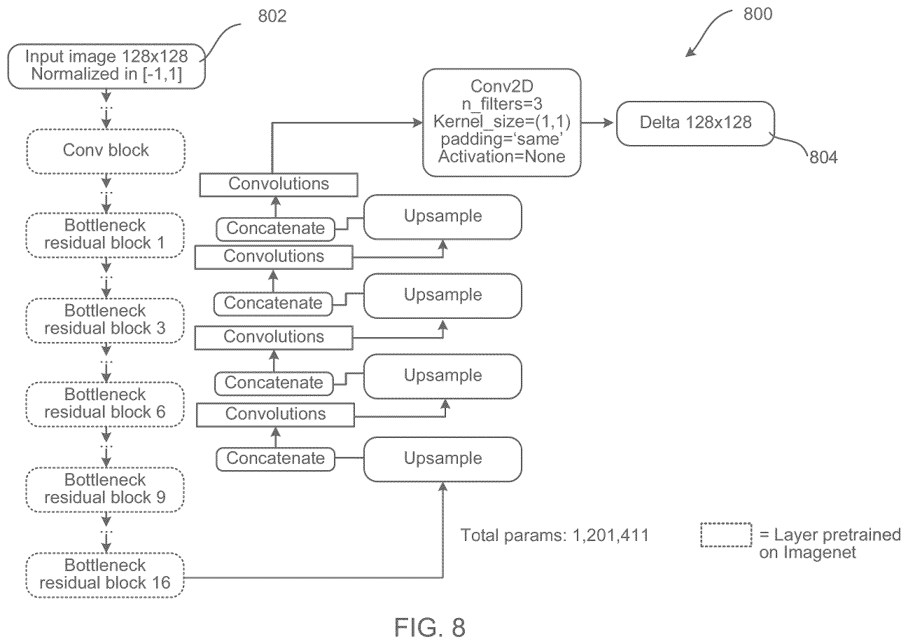

FIG. 8 is a block diagram of a neural network architecture 800 (e.g., based on MobileNet or the like) according to embodiments of the disclosure. The neural network architecture or neural network 800 takes as input the original image 802 and it is trained to predict the delta 804 between the color corrected image and the input image according to a residual learning scheme.

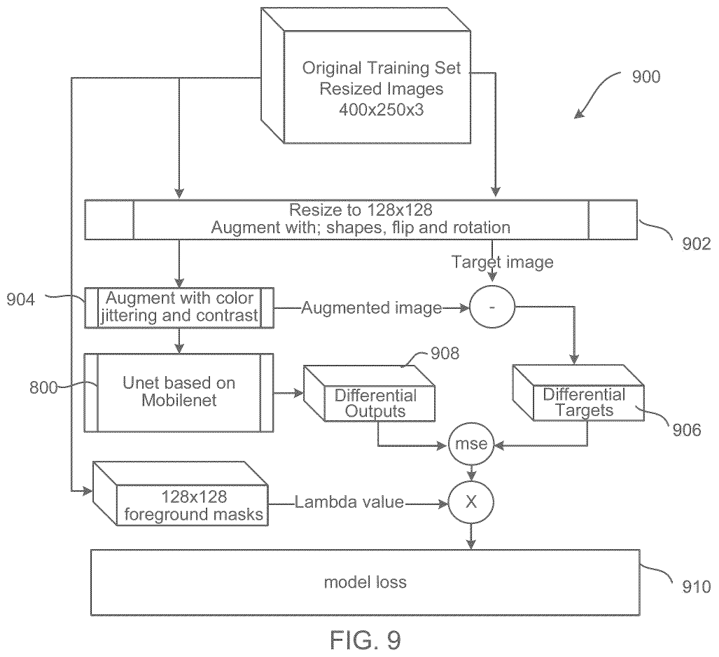

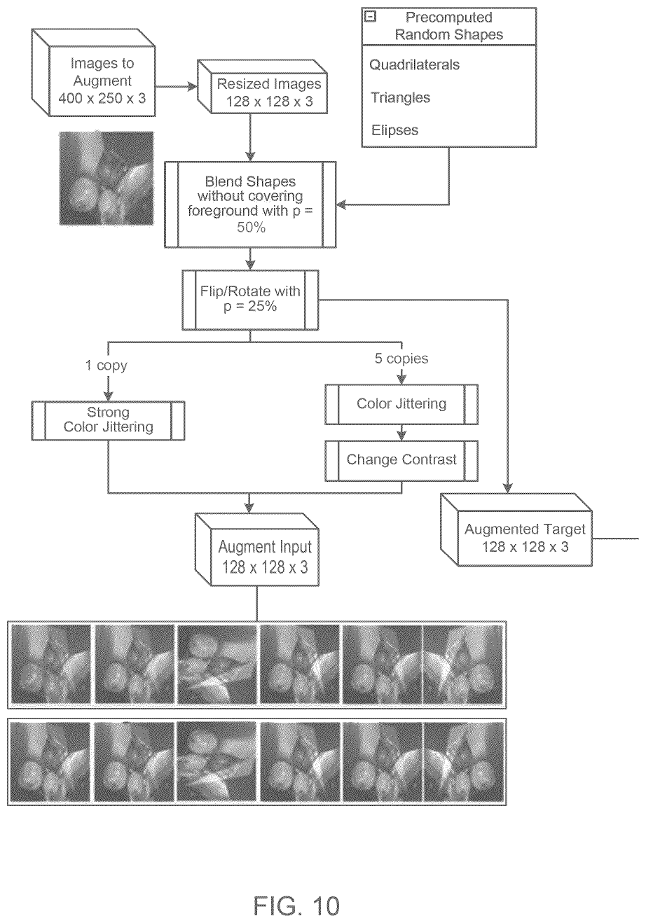

FIG. 9 is a block diagram of a network training structure 900 for the neural network 800 of FIG. 8 with additional details expanded as shown in FIG. 10 according to embodiments of the disclosure.

The image preprocessing pipeline involves several steps:

At operation 902:
Image Resizing: Images may be resized to match the network's input size.
Data Augmentation: To enhance the training dataset, data augmentation may be performed on 25% of the training images. This augmentation includes flipping or rotating the images.

At operation 904, augmentation by color jittering and contrast may be performed on the images.
Color Shapes Augmentation: For 50% of the images, color shapes are applied as an augmentation technique. These shapes, such as ellipses, quadrilaterals, or triangles, are filled with random colors. Importantly, these colors are controlled in terms of hue and saturation to ensure they don't overlap with the produce items. This precision is achieved because segmentation masks are possessed for every image. This augmentation strategy helps the network develop robustness to unexpected color artifacts, such as colorful clothing or strong reflections.
Further Augmentation Techniques: To enhance the robustness of the color correction network to varying white balance conditions and to introduce controlled variations in contrast and color, the following additional augmentation strategies may be employed:
   White Balancing Emulator: The original image may be augmented four times using a white balancing emulator. This step helps the network adapt to different white balancing conditions that may be encountered during deployment.
   Channel Shift: An extra image is provided to the network with a constant shift applied to one or two color channels. The intensity of this shift falls within the range of +/−20. This step is intended to expose the network to more aggressive color variations, allowing it to better handle challenging color situations.
   Contrast Variation: Contrast variation may be added as the last augmentation step.

These augmentations collectively contribute to preparing the network for a wider range of real-world scenarios and variations in image quality. Differential targets 906 may be generated based on the augmented images and the target images, and the model loss 910 may be determined based on the differential targets 906 and the differential outputs 908 generated from the neural network 800.

For effective color correction, a training set with normalized lighting conditions may be utilized. This normalization may be achieved with a system that projects the original training images into a reference color space based on the background, rather than the foreground. The training images may present the same background, and based on its variation it is possible to deduce a mapping function to normalize as much as possible the reference training images in the same lighting condition.

FIG. 10 is a block diagram showing additional expanded details of the neural network of FIG. 8.

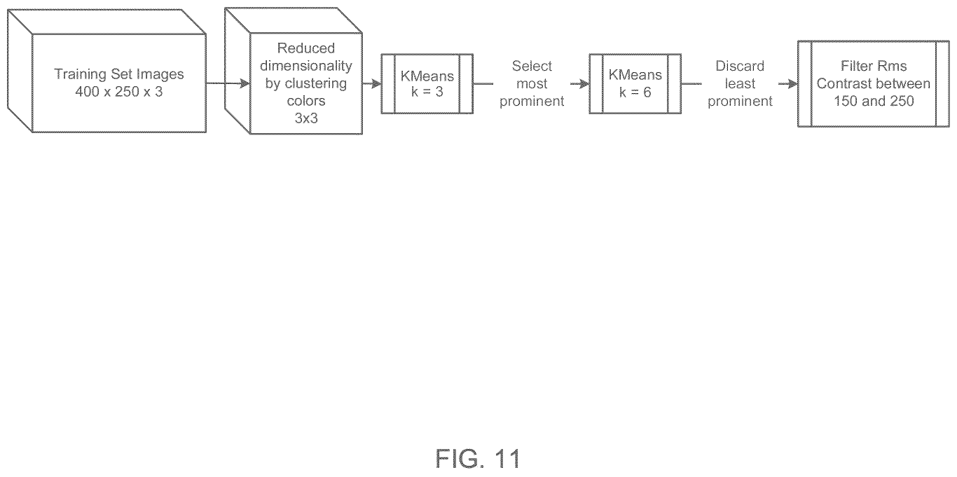

FIG. 11 is a block diagram illustrating an algorithm 1100 implemented in a method for computing reference color spectrum according to embodiments of the disclosure. The reference spectrum computation may be configured to enforce a more consistent color spectrum across the entire training set. It begins by matching the histogram of each image with a reference average histogram. To select this reference portion, the outlier may be filtered out. Outliner filtering may be performed by dimensionality reduction 1102 and cluster analysis 1104.

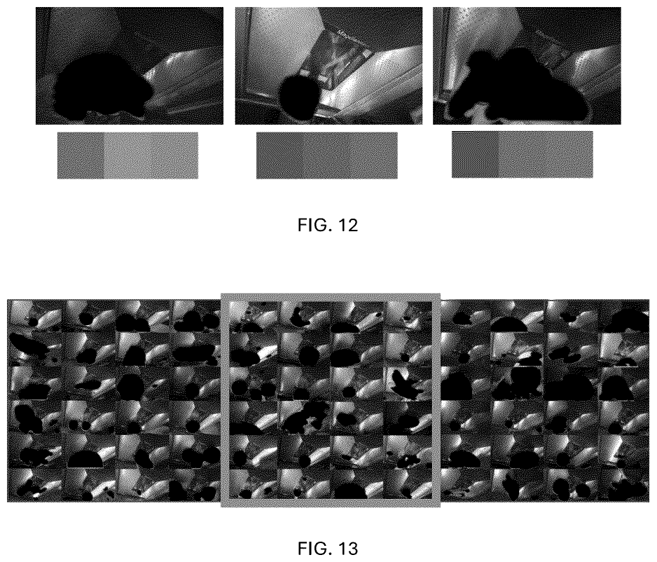

Dimensionality Reduction: The foreground produce may be removed, and the resulting image dimensions are reduced by representing them with centroids of clusters obtained through K-means clustering (k=3) applied to pixels. This results in the extraction of the three most representative colors, focusing on hue (FIG. 12).

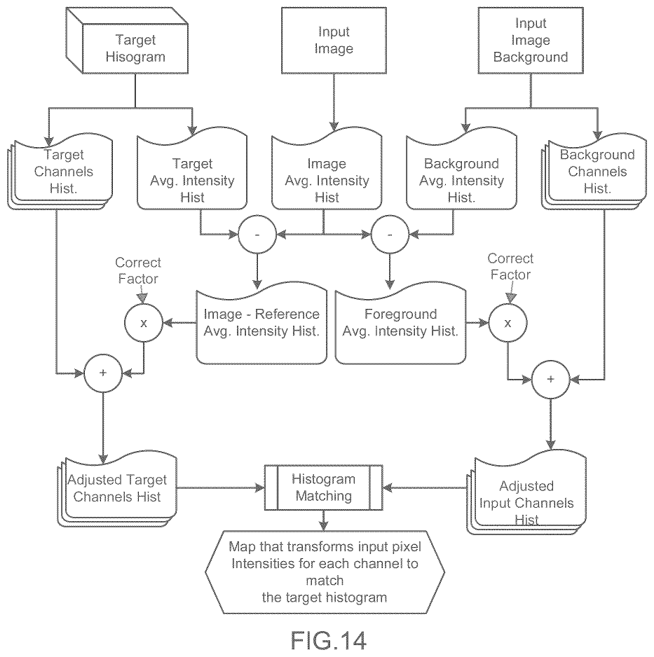

Cluster Filtering: These compact representations are clustered to identify clusters with similar light hues, selecting the most natural one. Clustering may be performed with k=6 keeping the most numerous cluster. Filtering is further applied based on RMS contrast (below 250 or above 150) to obtain a subset of reference images (FIG. 13).

Average Reference Histogram: The average reference histogram is computed using these filtered images, ensuring a consistent color spectrum for the training set.

Color Spectrum Normalization for Groundtruth: Matching the histogram of training set images with the reference creates a normalized color condition. However, this process may be complicated because the foreground histogram (e.g., the produce item) often dominates the background histogram (e.g., the platter), which tends to be monochromatic.

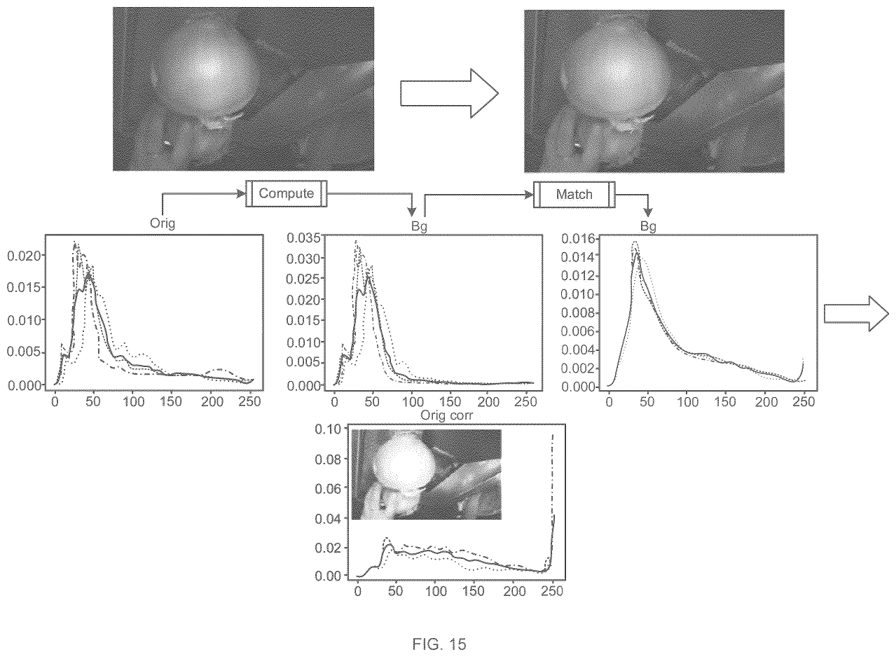

FIG. 14 is a block diagram illustrating a histogram matching process 1400 with corrections according to embodiments of the disclosure.

Normalization: All histograms are scaled to a range between 0 and 1, in an embodiment.

Histogram Matching Process with Corrections: During the matching process, the target histogram is adjusted to align with the linear average luminosity (e.g., sum of all channels) of the original image. Meanwhile, the original image histograms, computed solely for the background, are modified to align with the linear average luminosity of the entire image, encompassing both background and foreground. In this way color correction is specifically applied based only on the background, preserving the overall luminosity of the original image.

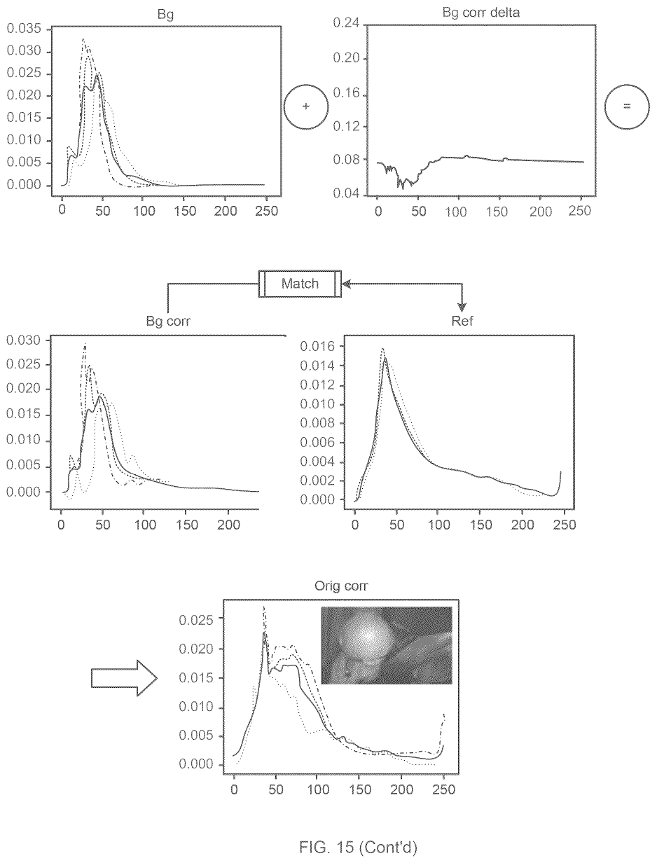

FIG. 15 shows results illustrating histogram matching 1500 with correction compared to without correction. The original image and the color may be matched over the graph. In the top row, the histogram matching is depicted without any correction. In the second row, the effect of compensating the input image's background histogram using the overall image luminosity is observed. In the last row, the final matching result is shown, which is achieved by also adjusting the reference histogram based on the overall luminosity of the input image. This final matching preserves the color matching according to the background while preserving the entire image's luminosity. This approach ensures consistent and normalized color conditions for the training set, even when dealing with varying lighting and foreground-background disparities.

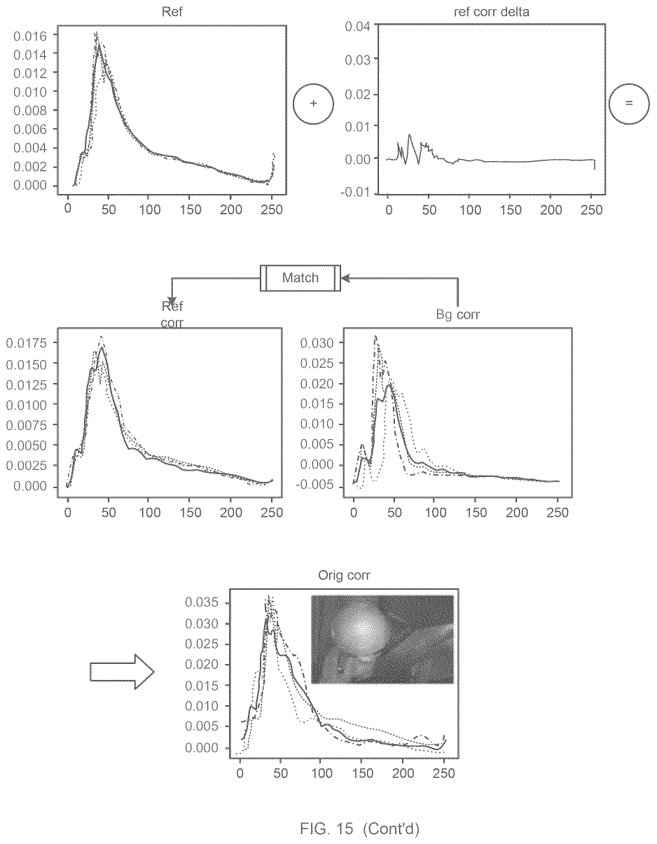

FIG. 16 illustrates the results illustrating the effect of the color correction network on 3 different group of images, in which the color corrected group is much more uniform. To assess the performance of the color correction to improve on produce classification, the same classifier may be trained and tested with and without the color correction.
Experiments may be performed using two distinct datasets:
Dataset D1: This dataset comprises approximately 62,000 images, which were used for both training and testing.
Dataset D2: In contrast, D2 serves as a standalone test dataset, consisting of roughly 17,500 images. It exhibits variations in lighting conditions and class distribution compared to D1.

To ensure robust evaluation, a K-fold method may be employed to partition the images in D1 into five sub-datasets: Fold 0, Fold 1, Fold 2, Fold 3, and Fold 4. Each fold is comprised of both a training dataset (approximately 49,000 images) and a test dataset (around 12,500 images). Dataset D1 is consistent in terms of light color and the training set of Fold 0 has been used to train the color correction network. Dataset D2 presents images captured under a significantly different color of light compared to the training set and was not used in the training of the color correction network.

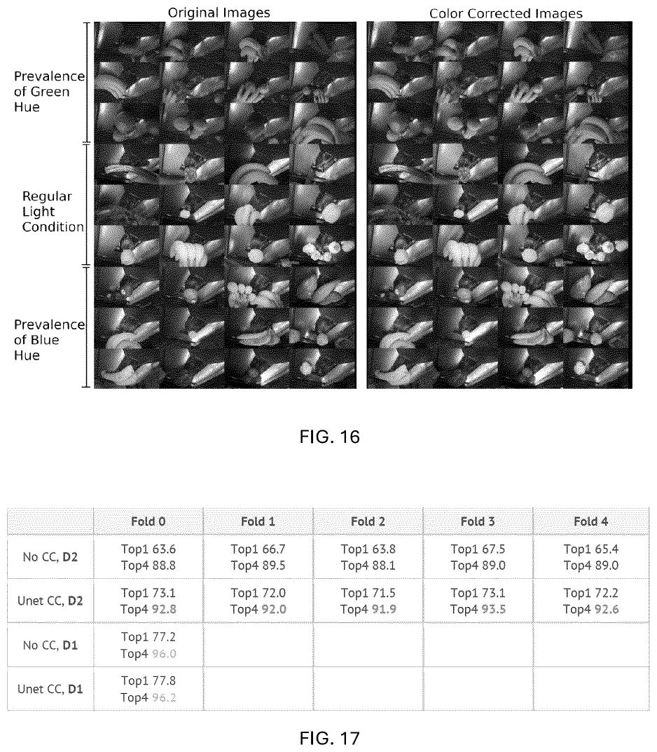

FIG. 17 shows a table showing a comparison of classification results for datasets D1 and D2 under two conditions: without color correction (No CC) and with a deep color correction network (Unet CC).
1. No Color Correction (No CC): In this scenario, no color correction is applied to the images.
2. With Deep Color Correction (Unet CC): In this scenario, the deep color correction network is utilized to correct the colors in the images.

The results indicate a significant performance improvement for dataset D2 when using color correction, highlighting its effectiveness in addressing color-related challenges. However, for dataset D1, which exhibits a light color similar to that in the training set, the performance remains relatively consistent. It is noted that other folds of D1 were not tested due to overlap between their test sets and the images used for training the color correction in Fold 0 training set.

### Multi-Input, Multi-Head Neural Network for Robust Produce Recognition

Embodiments of the disclosure include a neural network architecture including a multi-input, multi-head neural network to improve the robustness (e.g., accuracy, reliability, etc.) of produce recognition solutions in retail (e.g., grocery store) environments. This system may address several challenges in automated produce recognition, including but not limited to: produce assurance, bagged detection, produce detection and background suppression that will be described more fully below.

Produce assurance may be implemented as an anti-theft measure in self-checkout systems, which may be helpful to prevent a specific type of theft that can render other security measures ineffective: disguising expensive items as produce. The following description provides an example of how this theft technique works and why produce assurance may be useful in combating it.

One technique may be referred to as the “banana trick” or other similar variations. In some situations, shoplifters may attempt to exploit self-checkout systems by intentionally misidentifying high-value items as low-cost produce (e.g., bananas). For example, the customer a might weigh an expensive cut of meat and enter the code for bananas into the customer interface, thereby paying a lower cost related to the cheaper item. This tactic can be applied to various products, effectively bypassing traditional anti-theft mechanisms.

Other anti-theft methods may not adequately detect such activities at self-checkout. For example, scan avoidance techniques are often used to detect the customer directly circumvents barcode scanning, however, such techniques would be techniques would not be triggered in this banana trick scenario since an item was weighed and passed through the scanning area, and added to the transaction. Weight control methods that detect discrepancies in the weight of the scanned item and the weight of the bagged item may also be fooled because the measured weight will match the weight of the item added to the transaction.

Produce assurance methods of the disclosure may be employed as solution this theft technique. Such a dedicated produce rejection network may act as a final safeguard against such theft. By accurately distinguishing between actual produce and non-produce items, shoplifters may be prevented from exploiting the system by misclassifying expensive items. Produce assurance may close a critical security gap in self-checkout systems, ensuring that other anti-theft measures remain effective. Without it, the “banana trick” and similar tactics can lead to significant financial losses for retailers. Traditionally, produce rejection in automated checkout systems relies heavily on the classification score produced by a neural network. If the network's confidence in classifying a particular item as a known produce type is below a certain or predetermined threshold, the item is flagged as “non-produce.” Conventional approaches suffer from several drawbacks, especially in the context of continuous learning.

One drawback of conventional systems relates the classification of novel produce (i.e., a new type of produce not present in its training data). When a neural network of self-checkout system that employ conventional product assurance methods encounters a new type of produce not present in its training data, the neural network may assign a low confidence score, leading to its rejection. This hinders the system's ability to adapt to evolving produce varieties and customer preferences.

Another drawback of conventional systems involves the inconsistent rejection of non-produce items. Conventional methods may rely solely on classification scores for rejection, which can be unreliable. For example, non-produce items might occasionally receive higher scores due to variations in appearance or imaging conditions, leading to their acceptance.

Another drawback involves the unpredictability in continuous learning in conventional systems. As the neural network continuously learns and updates its parameters with new data, the classification scores for both produce and non-produce items can shift unpredictably. With conventional methods, it may be difficult to maintain a consistent and reliable threshold for rejection, potentially leading to increased errors over time.

In embodiments of the disclosure, bag detection may be employed in continuous learning of the neural network in order to enhance the accuracy and robustness of continuous learning systems for produce recognition.

Bag detection may enable preventing negative learning in the continuous learning systems for produce recognition. If the neural network of the self-checkout system is trained on a dataset containing a mix of bagged and non-bagged produce without explicit bag detection, the visual features of the bags may negatively influence the learned representations for the non-bagged produce itself. This can lead to misclassifications and reduced accuracy over time for non-bagged item. Thus, embodiments of the disclosure may train the neural network with a mix of bagged and non-bagged produce with explicit bag detection.

Bag detection may also enable specialized processing for online continuous learning for produce recognition. For example, identifying bagged items may enable the system to apply specialized training techniques for bagged produce. Embodiments of the disclosure may train the neural network for each class a separate second level classifier using either bagged and non-bagged items. This can improve the overall accuracy of the system and prevent degradation for classification specially for the non-bagged case.

Bagged detection may also facilitate data collection and labeling for offline training of the produce recognition system. In a continuous learning scenario, the bag detection network can help automatically identify and separate bagged items from the incoming data stream. This facilitates the collection of more targeted training data for specific produce types, even without explicit user input or ground truth labels.

Bag detection may also contribute to produce detection and background suppression. Accurately locating the produce within the image is beneficial for efficient classification. This embodiment utilizes a foreground detection network, trained on synthetic data, to generate a precise mask of the produce item, effectively isolating it from the background and maximizing the resolution of the relevant image region.

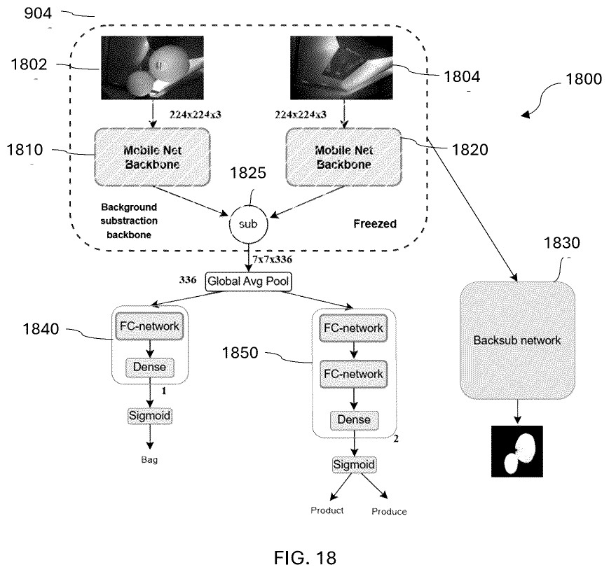

FIG. 18 is a block diagram providing details of an architecture for a multi-input, multi-head neural network 1800 according to embodiments of the disclosure. In particular, the network architecture may leverage a shared, multi-input, convolutional backbone and three task-specific heads. The backbone may be a frozen image encoder (e.g., MobileNet) that is run on both a live image 1802 and a stored background image 1804 to compute feature differences at three different scales. These feature differences, which suppress the background contribution to highlight foreground objects, may be fed to the three task specific heads. In particular, the globally pooled features from the last scale may be used as input for two shallow fully-connected neural networks (FCN), while the features differences at the three considered scales are used as skip-connections within a convolutional decoder. The first FCN establishes whether the live image contains a produce or any other item, the second FCN whether the produce present in the live image is bagged or not, whereas the U-Net provides foreground/background segmentation of the live image.

Such embodiments may enables produce assurance to avoid weighing an expensive item while entering the code of a cheap one, while also routing the live image 1802 toward classifiers trained to recognize bagged and non-bagged produces, which helps improving the overall classification accuracy. In other words, based on the results of the multi-head network (e.g., bag or no bag, produce or non-produce), the live image may be provided to a different classifier that is more appropriate for the situation. For example, the processor may route the captured image to a classifier specifically trained for classifying bagged produce items responsive to the bag detection network determining the presence of a bag holding the item and the produce rejection network determining that the item is a produce item. The processor (or multiple processors) may also route the captured image to a classifier specifically trained for classifying non-bagged produce items responsive to the bag detection network determining the absence of a bag holding the item and the produce rejection network determining that the item is a produce item.

In addition, the network may be focused on the foreground so as to perform produce recognition on a high-resolution crop of the live image 1802. The heads may be trained on suitable mixes of synthetic and real images (in particular, only the segmentation U-Net is trained on synthetic data only). In some embodiments, the background image 1804 may be a factory-stored background image, which may be replaced by a site-specific one when installing a new scanner in some embodiments.

Referring specifically to FIG. 18, the neural network 1800 includes a multi-input CNN backbone, in this case two MobileNet models 1810, 1820 process both the live image 1802 from the scanner's camera (e.g., foreground image) and a reference background image 1820 that may be captured previously, such as at system startup or other reference time. In some embodiments, processing these images 1802, 1804 up to block 16 of the CNN provides a 7×7×336 tensor representation for each.

A background subtraction process 1825 may subtract the background tensor from the foreground tensor to effectively removes background information in the feature space, enhancing the network's focus on the produce item.

The neural network 1800 may include a multi-head architecture in which the resulting tensor feeds into three distinct networks:
Foreground Detection Network 1830: A modified U-Net architecture with skip connections from the CNN layers performs background subtraction at multiple levels of the feature pyramid, generating a binary mask to isolate the foreground (produce).
Bag Detection Network 1840: A network branch with an average pooling layer and a fully connected layer classifies the presence of bags.
Produce Rejection Network 1850: This branch, featuring average pooling and two fully connected layers, determines whether the item is produce or non-produce.

As a result, the neural network 1800 may include a lightweight neural network architecture configured to perform different useful ancillary functions that improve both produce recognition as well as loss prevention. The different modules may include a shared backbone providing multi-scale feature differences to a plurality (e.g., three) of task-specific heads.

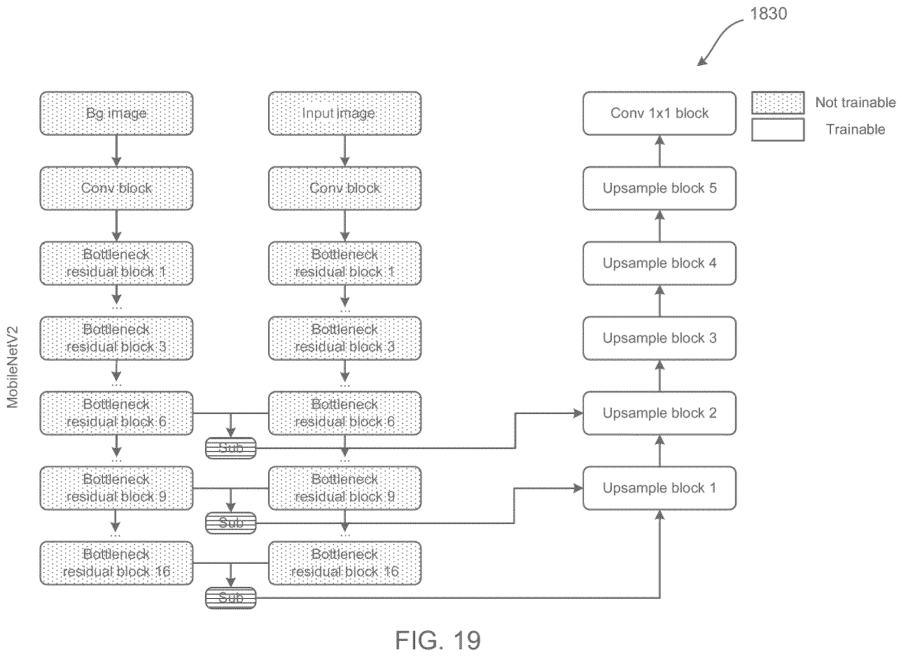

FIG. 19 provides additional structure of the background subtraction network 1830. Instead of the classic skip connection, the background subtraction network uses as input of the three skip connection blocks the residual block filters of the input image minus the correspondent residual block filters of the background image effectively computing background substruction in the feature space of CNN at different level of the feature pyramid.

### Training

In some embodiments, the MobileNet weight may be pretrained on ImageNet to maintain as much as possible general features and not overfit the training set. The foreground detection network may be trained using synthetic images and a dice loss function. The bag detection and produce rejection networks may be trained with a combination of real and synthetic images using binary cross-entropy and categorical cross-entropy loss functions, respectively. An Adam optimizer (Adaptive Moment Estimation) may be used for training the bag detection and produce rejection networks. To train the produce rejection network, a system may be configured to generate realistic synthetic images of products. This system used a dataset containing over 10,000 product images, to create 3D models placed on a virtual scanner plate. This approach generated a vast number of non-produce images for training.

In addition to the synthetic data, a lab-collected set of images and a collection of real produce images (both bagged and non-bagged) from a set of images or produce. The training dataset may be carefully balanced with an equal number of produce and non-produce images. This balanced approach aimed to achieve high recall for produce (correctly identifying most produce items) and high precision for non-produce (minimizing instances where a produce item is mistakenly classified as non-produce). This strategy prioritizes avoiding false positives, ensuring that produce items are not incorrectly rejected.

### Background Image Update

In some embodiments, the multinet network may employ a background subtraction initial phase to mitigate the influence of extraneous background features in the captured image. This may be achieved by utilizing a reference image of the empty scanner plate, captured under controlled ambient lighting conditions during factory calibration. This reference image serves as an input to the network, enabling it to differentiate between the region of interest (ROI) on the scanner plate and the surrounding environment.

The network may be trained to be robust against variations in lighting and background clutter, however, its performance is optimized when the background reference image closely approximates the actual background conditions during image acquisition. To improve performance, a robust background capture mechanism may be employed. This mechanism may be utilized to reliably capture a new reference image during system initialization, accounting for any changes in ambient lighting or scanner placement that may have occurred. This process enhances the network's ability to isolate the ROI and improve the accuracy of downstream tasks.

In some embodiments, the system may employ the scanner's weight sensor and a foreground detection network to ensure that the background image is always up-to-date and free of obstructions. In operation, the system takes a new picture and compares it to the current background image at startup. If the weight sensor detects no object on the scale and if the output mask of the Foreground Detection Network, run using the new image and the current background reference image, is small (meaning nothing is blocking the background), the new image becomes the current reference background image.

### Results

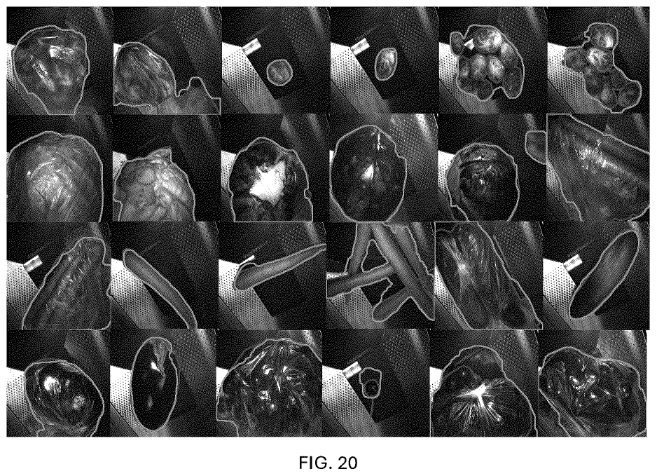

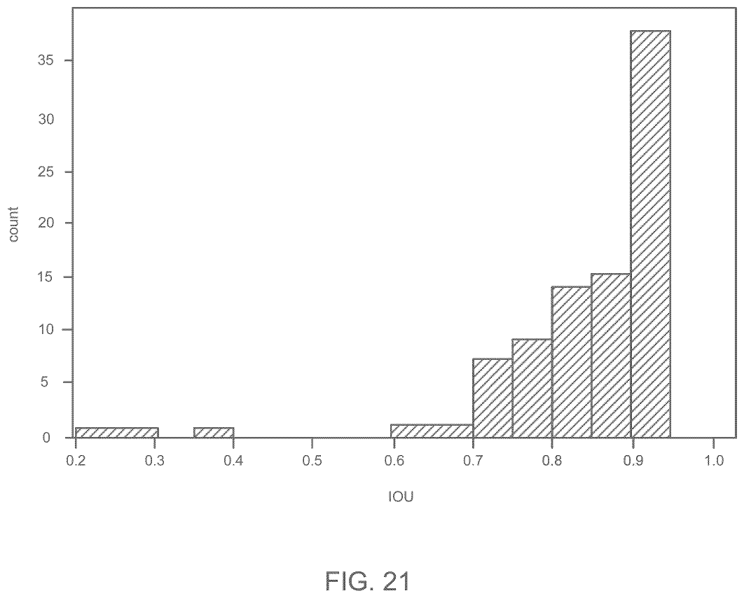

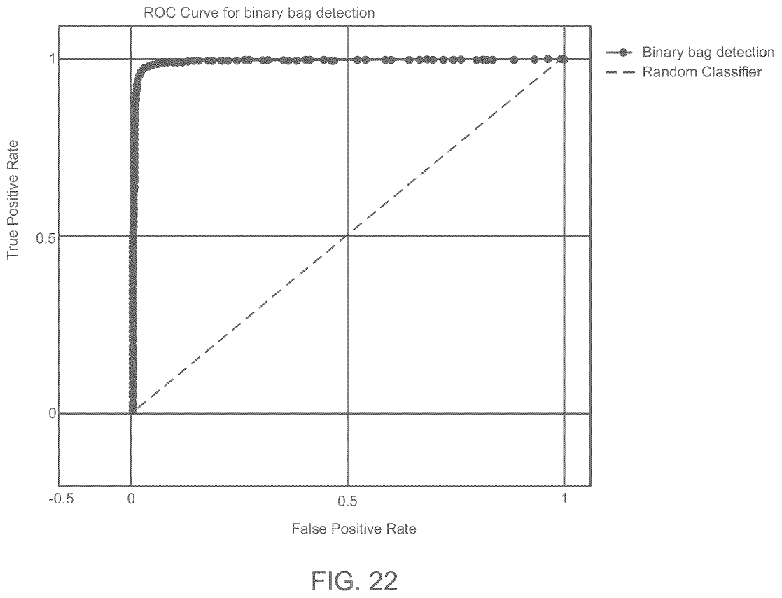

FIG. 20 shows a sample of foreground detection on a test dataset (in red the GT of the foreground and in green the output of the network). FIG. 21 is a histogram of the intersection over union (IOU) between output of the network and ground truth (GT) of the foreground on a LAB dataset. The average IOU in this example is 0.8604398557303. FIG. 22 is a graph showing a receiver operator characteristic (ROC) curve for the bag detection according to embodiments of the disclosure as compared to a random classifier.

The model threshold may be selected to improve the precision of the system. Indeed, if a bag is not identified by the model, it is likely to be very transparent or in the side of the image. The threshold to get these results is obtained by selecting where the Dataset1 precision reaches 99%, and then is kept the same for test set Dataset2.

| Dataset | Count | Precision | Recall | Accuracy |
|---|---|---|---|---|
| Dataset1 | 25215 | 99.0 | 92.5 | 95.9 |
| Dataset2 | 32034 | 96.7 | 97.3 | 97.2 |

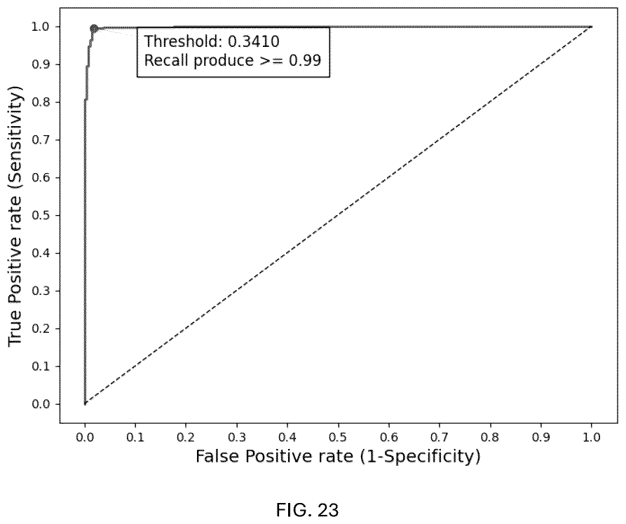

FIG. 23 is a graph showing the ROC curve for the produce rejection according to embodiments of the disclosure. In some embodiments, over 97% accuracy may be achieved with 99% recall for produce item. While it may be avoided generating as much as possible false positive exception from produce item, almost 94% of the non-produce item may be correctly detected.

| Metric | Produce | Non-produce item |
|---|---|---|
| Accuracy | 97.11 | 97.11 |
| Precision | 96.3 | 98.5 |
| Recall | 99.11 | 93.93 |

### Methods for Preventing Performance Degradation on Continuous Learning System

Embodiments of the disclosure may also include methods for preventing performance degradation on continuous learning system for produce recognition. Continuous learning systems deployed in scanners (e.g., bi-optic scanners) are designed to improve their performance over time by constantly collecting and learning from new images of produce (e.g., fruit, vegetables, etc.). This captured image data may reflect variations in appearance, lighting conditions, and even the unique environments of different stores.

Continuous learning processes are vulnerable to training data poisoning. For example, the system may rely on user input (e.g., through direct selection, confirmation of suggested options, etc.) and/or barcode scans to label the collected images. Unfortunately, these labeling methods are not foolproof. Users can make mistakes, intentionally mislabel items (e.g., to commit theft), or be confused by similar-looking produce. These incorrect labels “poison” the training data by introducing errors that the system learns from. As the system continuously incorporates this corrupted data, its performance can actually degrade over time. Instead of becoming more accurate, the system might start misidentifying produce, leading to frustration for customers, delays at checkout, and potential losses for the store. This phenomenon is particularly problematic in continuous learning systems because they are constantly updating their knowledge based on new, potentially flawed information.

Therefore, embodiments of the disclosure focus on mitigating the risk of data poisoning by introducing a mechanism to filter and validate training data, ensuring that the system learns from reliable information and maintains its accuracy over time, even in the presence of noisy or incorrect labels. Embodiments include a method to filter training data and minimize the impact of inaccurate labels by leveraging the varying levels of reliability in data sources:

Barcode scan data may be considered the most reliable source for identifying produce, as produce stickers are rarely misapplied. User confirmation based on suggestions generated by the system may be considered relatively reliable, as it aligns with the system's current classification, but may be also be biased by existing performance. Manual user selection may be considered the lease reliable source for identifying produce as it depends solely on user input, which can be prone to errors or intentional mislabeling.

To improve accuracy in the continuous learning system, a dual-output embedding network may be utilized. This network may be configured to generate both an embedding vector for image representation and a PLU commodity classification. PLU commodity represents broader categories like “apples” or “oranges,” simplifying classification compared to identifying specific varieties. This network may be trained to achieve high accuracy in PLU commodity prediction as described above regarding the PLU hierarchical classifier.

The PLU commodity output serves as a check against user-provided labels. Data from barcode scans is automatically accepted for training. However, for user-provided labels, the system verifies if the predicted PLU commodity matches the commodity of the user-selected item. If they match, the data is considered more reliable and added to the training set; otherwise, it is discarded to prevent inaccurate labels from corrupting the learning process.

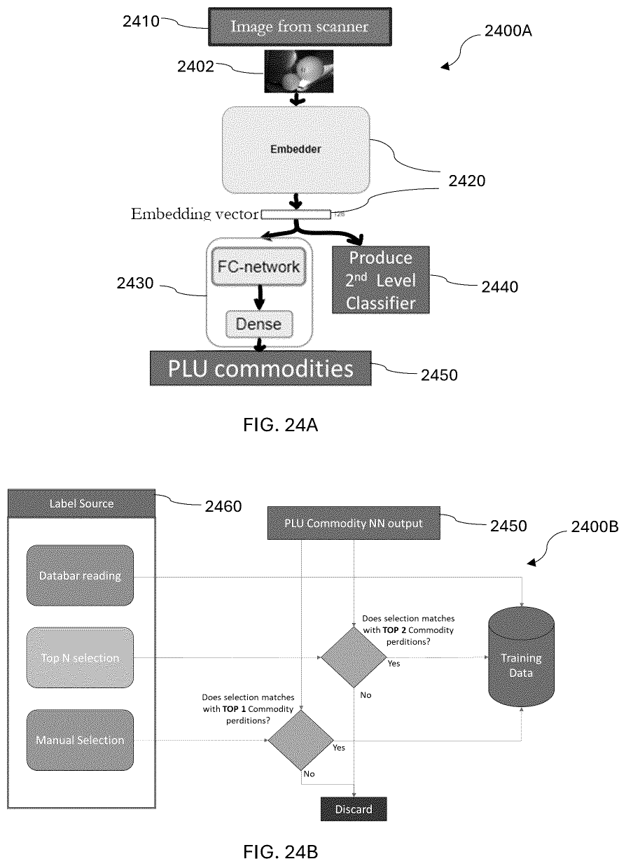

FIGS. 24A-24B are block diagrams for an architecture for a continuous learning system 2400 for produce recognition according to embodiments of the disclosure. The continuous learning system 2400 includes an image acquisition system 2410 including one or more cameras of a scanner (e.g., FIGS. 1-4) to capture images 2402 of produce items placed on the scanning scale or otherwise in a field-of-view. The system 2400 may also include a dual-output embedding network 2420 including a neural network with two distinct output branches. One output branch may include an embedding vector output, which generates a compact numerical representation (e.g., embedding vector) of the input image 2402, capturing the essential visual characteristics of the produce item. This vector may be fed into a classifier 2440 configured to perform the primary classification task, identifying the specific produce variety (e.g., “Granny Smith apple,” “Hass avocado,” etc.) The classifier 2440 may be configured to predict the specific produce variety based on the learned representations. This classifier 2440 can be continuously trained and updated as new data becomes available. Another output branch may include a PLU commodity output that is fed into an FC-network 2450 configured to predict the PLU (Price Look-Up) commodity 2450 of the produce item. The PLU commodity 2450 represents broader categories like “apples,” “citrus fruit,” “berries,” etc. and may serve as a secondary classification and be utilized in data filtering.

The system may further include a data labeling and consensus module 2460 configured to handle data labeling from different sources with varying levels of reliability. A first source may include a databar reading (e.g., barcode scan). This may be considered the most reliable source, as produce stickers with barcodes are rarely misapplied. Data from barcode scans may be directly used for training. Another source may include user confirmation from system suggestions (e.g., Top N suggestions). This source may be considered relatively reliable, as the user confirms a selection from the system's proposed classifications. However, this can be biased by the current performance of the classifier. Another source may be include manual user selection. This source may be least reliable, as it relies solely on the user's input, which can be prone to errors or intentional mislabeling.

### Training

The continuous learning system employs different training approaches. A first training approach involves on premise continuous learning. Periodically (e.g., daily or weekly), the on-premise server retrains the 2 level classifier using the collected data to improve accuracy. This process may require minimal computing power and can be done on a small computer or even the scanner itself. A second training approach may include offline learning (cloud-based) in which the system collects images, scanner predictions, user selections, etc. and stores them on a local server. The server may periodically transmit this data to a cloud-based system. The cloud system may be configured to aggregate data from multiple stores, performs statistical analysis, and uses the data to retrain the embedder network periodically (e.g., multiple times per year). This process may require a large dataset (100 k+ images) to enhance the system's overall performance.

The system 2400B uses a “consensus check” via the consensus module 2460 to ensure the quality of its training data. This check involves comparing the user's label for a produce item with the PLU commodity predicted by the system's embedding network. If the label comes from scanning a barcode, the image is automatically accepted for training, as barcodes are considered highly reliable. If the user selects a produce item from the system's suggestions (Top N options), the system checks if the PLU commodity of the user's selection matches either the first or second most likely PLU commodity predicted by its internal network. If there's a match, the image is used for training; otherwise, the image is discarded. This allows for some flexibility in user choices while still maintaining data quality. If the user manually selects a produce item that's not among the system's suggestions, the system checks if the PLU commodity of the user's selection matches the most likely PLU commodity predicted by its network. Only if there's an exact match is the image used for training. This stricter rule reflects the higher uncertainty associated with manual selections. In simpler terms, the system may trust barcode scans completely. For user-provided labels, it cross-checks the user's choice with its own prediction to ensure a higher degree of confidence before using the data for training. This helps prevent incorrect labels from negatively impacting the system's learning process.

By filtering training data based on a consensus mechanism, the system minimizes the impact of inaccurate labels, leading to more accurate produce recognition. The dual-output embedding network and the consensus mechanism enhance the system's robustness to noisy data and user errors. As a result, a comprehensive solution for accurate and reliable produce recognition in grocery store scanners may be provided, addressing the challenges of continuous learning in a real-world setting. By combining advanced embedding techniques with a robust consensus mechanism, the system ensures high performance and adaptability, ultimately improving the efficiency and customer experience at grocery checkout lanes.

The following table shows the performance of the PLU commodity prediction for a test dataset for Top1 and Top2 results.

| | recall | recall | # test | # of different PLU |
|---|---|---|---|---|
| | top1 | top2 | images | commodities |
| Non-Bagged | 96.80% | 98.70% | 45201 | 54 |
| Bagged | 79.70% | 88.30% | 32603 | 59 |

### Enhanced Checkout for Produce with Item Quantity Prediction

Embodiments of the disclosure may further include an improved self-checkout system for produce recognition with item quantity prediction. Conventional self-checkout systems in grocery stores rely on user input for the quantity of produce items sold by count (e.g., apples, lemons). This reliance on user honesty creates opportunities for theft, as there is no mechanism to verify the declared quantity against the actual number of items.

Embodiments may include an improved self-checkout system equipped with an integrated scale configured to measure the weight of produce placed on the scanner, a produce recognition and classification system configured to employ computer vision technology that identifies the type of produce, and a machine learning model (e.g., a Gaussian model) configured to predict the likely number of items based on the measured weight and known produce characteristics. The method for operating a self-checkout system for produce recognition and item quantity prediction according may include a training phase and a prediction mode when in use by a customer.

During the training phase, the self-checkout system may gather data from the Point of Sale (POS) system, including the produce type and the corresponding quantity for one or more items sold by count for a given self-checkout transaction. In some embodiments, this data entry may occur manually by the customer selecting the produce type and count on a user interface displayed by a touch screen of the self-checkout system. In some embodiments, this data entry may occur automatically responsive to the system (e.g., imager, processor, etc.) identifying a produce type, such as via computer vision techniques or other similar detection methods. In some embodiments, the data entry may be a combination of manual and automatic methods, such as a produce item being identified automatically via computer vision, neural network, or other methods, with other data (e.g., quantity) being entered or adjusted manually by the user. The weight of the produce items from the integrated scale of the scanner. This weight data may be used to calculate the average weight and standard deviation for each produce class, building a Gaussian model to represent the weight distribution for each item type. Thus, the self-checkout system may configured to predict the number of items based on the Gaussian model for a specific produce type.

During the prediction mode, the predicted quantity of the produce item may be displayed (e.g., via the user interface on the electronic display) to the customer. The customer can either accept the predicted quantity or manually adjust it. The self-checkout system calculates the probability of the customer-selected quantity being correct, given the measured weight and the Gaussian model. If this probability falls below a predefined or predetermined threshold (e.g., 90%), and the entered quantity is lower than the predicted quantity, the self-checkout system flags the transaction as potentially fraudulent and alerts store staff for verification.

In some embodiments, the following formula may be used to train weights based on Gaussian model:

$$\overline{x} n = \overline{x} n - 1 + \frac{1}{n} ( {x}_{n} - \overline{{x}_{n - 1}} )$$

where x̅n is the current running weight average for a class

$${s}_{n}^{2} = \frac{1}{n} {\sum }_{i = 1}^{n} {( {x}_{i} - \overline{{x}_{n}} )}^{2}$$

where

$${s}_{n}^{2}$$

is the current running standard deviation for a class

In some embodiments, the following formula may be used to estimate current weight based on gaussian model:

$$Estimated Quantity = max ( ⌈ \frac{Weight}{Average Weight} ⌉ , 1 ) .$$

If the computed value is less than 1, the value may default to 1 to ensure a meaningful result.

In some embodiments, the following formula may be used to estimate probability given a selected quantity:

$${P}_{gaussian} = qty \cdot \frac{1}{std \sqrt{2 π}} \cdot exp ( - \frac{{( \frac{Weight}{qty} - Average Weight )}^{2}}{2 \cdot {std}^{2}} ) ,$$

where:
Average weight is the average weight of the product;
std is the standard deviation of the product weight;
qty is the quantity being validated; and
weight is the weight detected by the scale.

Embodiments of the disclosure may result in numerous benefits, such as reduced theft by providing an objective measure of produce quantity and reducing the potential for customer dishonesty; improved accuracy by leveraging machine learning to accurately estimate item counts, thereby reducing errors and improving efficiency; and an enhanced customer experience by offering a seamless and user-friendly self-checkout experience while maintaining security by suggesting a default value to accept potentially reducing the interactions with the POS.

The foregoing method descriptions and/or any process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be communicated (e.g., passed, forwarded, and/or transmitted) via any suitable means including memory sharing, message passing, token passing, network transmission, etc.

The actual software code or specialized control hardware used to implement these systems and methods is not limiting of the disclosure. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The previous description is of various preferred embodiments for implementing the disclosure, and the scope of the invention should not necessarily be limited by this description. The scope of the present invention is instead defined by the claims.

What is claimed:

1. A produce recognition system for a scanning system in a retail environment, the system comprising:
a scanner including one or more imagers configured to capture images of an item within its field-of-view; and
at least one processor operably coupled with the one or more imagers to receive the captured images and execute a neural network having a multi-input, multi-head architecture including:
a foreground detection network configured to perform background subtraction to isolate the produce item in the foreground;
a bag detection network configured to determine presence of a bag holding the item; and
a produce rejection network configured to determine whether the item is a produce item or a non-produce item.

2. The produce recognition system of claim 1, wherein the second level classifier of the neural network is trained for each class of produce item for both bagged and non-bagged items.

3. The produce recognition system of claim 1, wherein the neural network includes a multi-input CNN backbone.

4. The produce recognition system of claim 1, wherein the multi-input CNN backbone is a MobileNet architecture.

5. The produce recognition system of claim 1, wherein the at least one processor is configured to process the captured image differently based on results from the bag detection network and the produce rejection network.

6. The produce recognition system of claim 1, wherein the at least one processor is configured to route the captured image to a different classifier based on results from the bag detection network and the produce rejection network.

7. The produce recognition system of claim 1, wherein the at least one processor is configured to:
route the captured image to a classifier specifically trained for classifying bagged produce items responsive to the bag detection network determining the presence of a bag holding the item and the produce rejection network determining that the item is a produce item; and
route the captured image to a classifier specifically trained for classifying non-bagged produce items responsive to the bag detection network determining the absence of a bag holding the item and the produce rejection network determining that the item is a produce item.

8. The produce recognition system of claim 1, wherein the scanner is incorporated into a self-checkout system.

9. The produce recognition system of claim 1, wherein the at least one processor is further configured to execute a produce classification system based on the captured image and the results of the multi-input, multi-head architecture.

10. The produce recognition system of claim 9, wherein the produce classification system is configured to determine a likely number of produce items based on a classified type of produce, a measured weight, and known produce characteristics for the classified type of produce.

11. The produce recognition system of claim 10, wherein the produce classification system is trained according to a training phase including:
receiving an input of a produce type and quantity of produce items;
weigh the produce items; and
calculate an average weight and standard deviation for each produce class to build a Gaussian model representing a weight distribution for each produce type.

12. The produce recognition system of claim 11, wherein the produce classification system is configured to operate in a prediction mode to determine a predicted quantity of the produce item based on Gaussian model and a determined weight during a real-time transaction.

13. The produce recognition system of claim 12, wherein the produce classification system is configured to compare the predicted quantity of the produce item and compare with a customer-selected quantity of the produce item during the transaction to determine a probability value that the customer-selected quantity is correct.

14. The produce recognition system of claim 13, wherein the produce classification system is configured to generate an alert responsive to the probability value being below a predetermined threshold.

15. The produce recognition system of claim 9, wherein the produce classification system is a continuous learning model that updates its training data in response to real-time data from a transaction with a customer.

16. The produce recognition system of claim 15, wherein the at least one processor is further configured to execute a data labeling and consensus module during the continuous learning process configured to handle the real-time data differently depending on the source of the real-time data.

17. The produce recognition system of claim 9, wherein the produce classification system is a continuous learning model that updates its training data in response to offline data from a transaction with a customer stored in a cloud server.

18. The produce recognition system of claim 15, wherein label data from a barcode read is automatically accepted for training, and label data from a user selection is accepted for training under stricter rules after cross-checks the user's selection with a list of Top N predictions generated by the produce classification system.

19. The produce recognition system of claim 9, wherein the produce classification system includes a hierarchical classifier including:
an embedded network configured to extract high-level features from the captured image; and
a second-stage classifier configured to the extracted features into class predictions such that a provided list of Top N predictions includes a grouping of produce items within a common class.

20. The produce recognition system of claim 9, wherein the at least one processor is further configured to perform color correction on the captured image prior to produce classification, the color correction based on a deep learning color correction architecture including an embedder configured to project images of produce into a latent feature space, after which resultant vectors are input into the produce classification system.
